(19) United States
(12) Patent Application Publication
(10) Pub. No.: US 2026/0304410 A1
(43) Pub. Date: Oct. 1, 2026

(54) Wireless Device, Network Node, and Methods Performed Thereby, for Handling a Bandwidth Part

(71) Applicant: Telefonaktiebolaget LM Ericsson (publ), Stockholm (SE)

(72) Inventors: Revathy Narayanan, Sollentuna (SE); Liping Zhang, Beijing (CN); Jan Christoffersson, Luleå (SE)

(21) Appl. No.: 19/475,817

(22) PCT Filed: Apr. 19, 2024
(86) PCT No.: PCT/SE2024/050386

§ 371 Date: Oct. 16, 2025

(30) Foreign Application Priority Data
Apr. 28, 2023 (WO) PCT/CN2023/091718

(51) Int. Cl. H04W 72/0457; H04W 68/02; H04W 72/231; H04W 74/0833; H04W 76/20; H04W 76/30

(52) U.S. Cl. CPC H04W 72/0457; H04W 68/02; H04W 72/231; H04W 74/0833; H04W 76/20; H04W 76/30

(57) ABSTRACT

A method, performed by a wireless device (130). The method is for handling a bandwidth part (BWP). The wireless device (130) operates in a wireless communications network (100). The wireless device (130) obtains (401) a first indication. The first indication indicates a first BWP, different than a second BWP. The second BWP is a subset of an initial BWP. The first BWP is for transmission by a network node (110) operating in the wireless communications network 100, of data to the wireless device (130) in inactive state.

### TECHNICAL FIELD

The present disclosure relates generally to a wireless device and methods performed thereby for handling a bandwidth part (BWP). The present disclosure further relates generally to a network node and methods performed thereby, for handling the BWP.

### BACKGROUND

Wireless devices within a wireless communications network may be e.g., User Equipments (UEs), stations (STAs), mobile terminals, wireless terminals, terminals, and/or Mobile Stations (MS). Wireless devices are enabled to communicate wirelessly in a cellular communications network or wireless communication network, sometimes also referred to as a cellular radio system, cellular system, or cellular network. The communication may be performed e.g., between two wireless devices, between a wireless device and a regular telephone and/or between a wireless device and a server via a Radio Access Network (RAN) and possibly one or more core networks, comprised within the wireless communications network. Wireless devices may further be referred to as mobile telephones, cellular telephones, laptops, or tablets with wireless capability, just to mention some further examples. The wireless devices in the present context may be, for example, portable, pocket-storable, hand-held, computer-comprised, or vehicle-mounted mobile devices, enabled to communicate voice and/or data, via the RAN, with another entity, such as another terminal or a server.

The wireless communications network covers a geographical area which may be divided into cell areas, each cell area being served by a network node, which may be an access node such as a radio network node, radio node or a base station, e.g., a Radio Base Station (RBS), which sometimes may be referred to as e.g., gNB, evolved Node B (“eNB”), “eNodeB”, “NodeB”, “B node”, Transmission Point (TP), or Base Transceiver Station (BTS), depending on the technology and terminology used. The base stations may be of different classes such as e.g., Wide Area Base Stations, Medium Range Base Stations, Local Area Base Stations, Home Base Stations, pico base stations, etc. . . . , based on transmission power and thereby also cell size. A cell is the geographical area where radio coverage is provided by the base station or radio node at a base station site, or radio node site, respectively. One base station, situated on the base station site, may serve one or several cells. Further, each base station may support one or several communication technologies. The base stations communicate over the air interface operating on radio frequencies with the terminals within range of the base stations. The wireless communications network may also be a non-cellular system, comprising network nodes which may serve receiving nodes, such as wireless devices, with serving beams. In 3rd Generation Partnership Project (3GPP) Long Term Evolution (LTE), base stations, which may be referred to as eNodeBs or even eNBs, may be directly connected to one or more core networks. In the context of this disclosure, the expression Downlink (DL) may be used for the transmission path from the base station to the wireless device. The expression Uplink (UL) may be used for the transmission path in the opposite direction i.e., from the wireless device to the base station.

The standardization organization 3GPP is currently in the process of specifying a New Radio Interface called NR or 5G-UTRA, as well as a Fifth Generation (5G) Packet Core Network (CN), which may be referred to as Next Generation (NG) Core Network, abbreviated as NG-CN, NGC, 5G CN or 5G Core (5GC). NG may be understood to refer to the interface/reference point between the Radio Access Network (RAN) and the CN in 5G/NR. In a 5G System (5GS), a radio base station in NR may be referred to as a gNB or 5G Node B. An NR UE may be referred to as an nUE.

### Internet of Things (IoT)

The Internet of Things (IoT) may be understood as an internetworking of communication devices, e.g., physical devices, vehicles, which may also be referred to as “connected devices” and “smart devices”, buildings and other items—embedded with electronics, software, sensors, actuators, and network connectivity that may enable these objects to collect and exchange data. The IoT may allow objects to be sensed and/or controlled remotely across an existing network infrastructure.

“Things,” in the IoT sense, may refer to a wide variety of devices such as heart monitoring implants, biochip transponders on farm animals, electric clams in coastal waters, automobiles with built-in sensors, DNA analysis devices for environmental/food/pathogen monitoring, or field operation devices that may assist firefighters in search and rescue operations, home automation devices such as the control and automation of lighting, heating, e.g. a “smart” thermostat, ventilation, air conditioning, and appliances such as washer, dryers, ovens, refrigerators or freezers that may use telecommunications for remote monitoring. These devices may collect data with the help of various existing technologies and then autonomously flow the data between other devices.

It is expected that in a near future, the population of IoT devices will be very large. Various predictions exist, among which one assumes that there will be >60000 devices per square kilometer, and another assumes that there will be 1000000 devices per square kilometer. A large fraction of these devices are expected to be stationary, e.g., gas and electricity meters, vending machines, etc.

### Machine Type Communication (MTC)

Machine Type Communication (MTC) has in recent years, especially in the context of the Internet of Things (IoT), shown to be a growing segment for cellular technologies. An MTC device may be a communication device, typically a wireless communication device or simply user equipment, that is a self and/or automatically controlled unattended machine and that is typically not associated with an active human user in order to generate data traffic. An MTC device may be typically simpler, and typically associated with a more specific application or purpose, than, and in contrast to, a conventional mobile phone or smart phone. MTC involves communication in a wireless communication network to and/or from MTC devices, which communication typically may be of quite different nature and with other requirements than communication associated with e.g., conventional mobile phones and smart phones. In the context of and growth of the IoT, it is evident that MTC traffic will be increasing and thus needs to be increasingly supported in wireless communication systems.

### Small Data Transmission (SDT)

In Rel-15, 3GPP introduced a new radio-access technology known as New Radio (NR). The technology was further enhanced in release 16, and will continue to evolve in release 17, and later. In NR, the device may be in Radio Resource Control (RRC) idle, in RRC connected or in RRC inactive state. Until release 16, the data transmission was possible only in RRC connected. Therefore, a User Equipment (UE) may have to transition to a connected state from idle or inactive states every time there may be data transfer between UE and gNB. The transition from RRC_Idle or RRC_Inactive state to RRC_Connected may lead to significant signalling overhead and power consumption, particularly for the UEs that may need infrequent transmission of small data packets. In RRC_Inactive state, the UE may have established RRC context and core network connection. Therefore, the transition from Inactive to Connected state may be relatively fast and may require less signalling, compared to the transition from Idle to Connected state.

To enable efficient transmission of small infrequent data packets, 3GPP has approved a new study item on NR small data transmissions in RRC_Inactive state. In Rel-17, mobile originated small data transmission (MO-SDT) was specified to allow small packet transmission for Uplink (UL)-oriented packets.

The new Release 18 expects mobile terminated (MT) Small Data Transmission (SDT), that is Downlink (DL)-triggered small data, to allow similar benefits, such as, 1) reducing signalling overhead and UE power consumption by not transitioning to RRC_CONNECTED and reducing latency by allowing fast transmission of, small and infrequent, packets, e.g., for positioning. The scope of this work item majorly addresses two main objectives: MT-SDT triggering mechanism for UEs in RRC_INACTIVE, supporting Random Access (RA)-SDT and Configured Grant (CG)-SDT as the UL response, and MT-SDT procedure for initial DL data reception and subsequent UL/DL data transmissions in RRC_INACTIVE.

MT-SDT may be understood to address application use-cases by typically reducing the overall signalling overhead with an aim to minimize the UE power consumption. Therefore, optimizations that reduce the number of signalling may be understood to a key factor to consider.

### SDT and Subsequent Transmissions

Rel-17 MO-SDT may be understood to allow UE originated data transmission while remaining in RRC_Inactive state. FIG. 1 is a schematic diagram illustrating MO-SDT baseline with subsequent transmissions. In the baseline approach, MO-SDT may allow a UE to request for a larger Message 3 grant, which the UE may use for transmitting UL data, as shown in FIG. 1. As depicted in FIG. 1, at 1, in Message 1, a UE in inactive state may send a preamble to a gNB which may indicate the request for the larger grant. At 2, the UE may receive Message 2, comprising a Random Access Response with the larger grant. At 3, the UE may then use the larger grant to send an RRCResumeRequest along with the UL data in Message 3. In this feature, the UE may be also allowed to transmit any pending UL data in its buffer as subsequent transmission. This may be understood to mean, along with Message 3, and the first UL transmission, the UE may indicate the pending data in its buffer using a Buffer Status Report (BSR) Medium Access Control (MAC) Control Element (CE). Based on the BSR information, the gNB may allocate further dynamic grants to the UE to transmit its pending UL data as subsequent transmission. At 4, the UE may receive a first additional UL grant from the gNB based on the BSR sent on Message 3, along with a Contention Resolution Identity (CRID). At 5, the UE may use the first additional grant to send subsequent UL data to the gNB. At 6, the UE may then receive an RRCRelease message from the gNB.

For Rel-18 MT-SDT, data transmission may be initiated from the gNB end. FIG. 2 is a schematic diagram illustrating MT-SDT baseline with subsequent transmissions. As depicted in FIG. 2, at 21, a UE in inactive state may receive a page from the gNB indicating that it should initiate RA. At 22, in Message 1, the UE may send a preamble to the gNB. At 23, the UE may receive Message 2, comprising a Random Access Response with the larger grant. At 24, the UE may send an RRCResumeRequest to the gNB. Once the gNB may receive RRCResumeRequest with an MT-SDT specific Resume Cause, the gNB may initiate DL transmission at 25. As mentioned in the Section entitled “Small Data Transmission (SDT)”, the Rel-18 MT-SDT WI may support subsequent transmissions as well. This may be understood to mean the first DL data transmission from the gNB end at 25 may be potentially followed by subsequent DL transmissions as shown in FIG. 2 at 26. At 27, the UE may send an optional UL acknowledgment to the gNB, along with a Release Assistance Information (RAI). At 28, the UE may then receive an RRCRelease message from the gNB.

### MO-SDT and Bandwidth Part Constraint

Rel-17 agreements constrain operation of SDT over initial Bandwidth part (BWP) with scheduling over fallback Downlink Control Information (DCI) formats, and Hybrid Automatic Repeat reQuest (HARQ)-based acknowledgements over common Physical Uplink Control Channel (PUCCH) formats. A BWP may be understood as a part of the total available bandwidth or frequency range. The initial BWP may be understood to refer to a common part of the total available bandwidth or frequency range, which may be configured in System Information (SI), which a UE may use, e.g., for idle and inactive procedures, before going to connected mode. One reason for the initial BWP constraint may be to render SDT procedure as close to legacy initial access procedure as possible. Secondly, with the aim to transmit only smaller amount of data as part of SDT, the feature expected to get sufficient resources even within the initial BWP. Additionally, the current standards may be understood to allow BWP switching after Message 4, if the UE is resumed to RRC_Connected state. BWP switching may be understood to allow that a UE may be configured with a different or larger part of the total available bandwidth. This may enable higher throughput. The UE capabilities may determine how wide the configured BWP may be.

In Rel-17 MO-SDT, the Physical Uplink Shared Channel (PUSCH) scheduling for Message 3 may be understood to be expected within the initial UL BWP. In 38.212, v. 17.3.0 this is explained as follows. The following information may be transmitted by means of the DCI format 0_0 with Cyclic Redundancy Check (CRC) scrambled by Temporary Cell Radio Network Temporary Identifier (TC-RNTI): Frequency domain resource assignment. The number of bits may be determined by the following:

$$⌈ {log}_{2} ( {N}_{RB}^{UL , BWP} ( {N}_{RB}^{UL , BWP} + 1 ) / 2 ) ⌉$$

bits if the higher layer parameter useInterlacePUCCH-PUSCH in BWP-UplinkCommon is not configured, where

$${N}_{RB}^{UL , BWP}$$

may be understood to be the size of the initial UL bandwidth part. For PUSCH hopping with resource allocation type 1: N_{UL_hop} Most Significant bit (MSB) bits may be used to indicate the frequency offset according to Table 8.3-1 in Clause 8.3 of [5, TS 38.213, v.17.3.0], where N_{UL_hop}=1 if

$${N}_{RB}^{UL , BWP} < 50 and {N}_{UL\_hop} = 2$$

otherwise.

$$⌈ {log}_{2} ( {N}_{RB}^{UL , BWP} ( {N}_{RB}^{UL , BWP} + 1 ) / 2 ) ⌉ - {N}_{UL\_hop}$$

bits may provide the frequency domain resource allocation according to Clause 6.1.2.2.2 of [6, TS 38.214, v.17.5.0]. For non-PUSCH hopping with resource allocation type

$$1 : ⌈ {log}_{2} ( {N}_{RB}^{UL , BWP} ( {N}_{RB}^{UL , BWP} + 1 ) / 2 ) ⌉$$

bits may provide the frequency domain resource allocation according to Clause 6.1.2.2.2 of [6, TS 38.214, v.17.5.0].

The same may be understood to be applicable for subsequent transmissions and retransmissions, as may be seen next, from 38.212, v. 17.3.0. According to 38.212, v. 17.3.0, the following information may be transmitted by means of the DCI format 0_0 with CRC scrambled by Cell Radio Network Temporary Identifier (C-RNTI) or Configured Scheduling-Radio Network Temporary Identifier (CS-RNTI) or Modulation and Coding Scheme Cell Radio Network Temporary Identifier (MCS-C-RNTI): Frequency domain resource assignment. The number of bits may be determined by the following:

$$⌈ {log}_{2} ( {N}_{RB}^{UL , BWP} ( {N}_{RB}^{UL , BWP} + 1 ) / 2 ) ⌉$$

bits if neither of the higher layer parameters useInterlacePUCCH-PUSCH in BWP-UplinkCommon and useInterlacePUCCH-PUSCH in BWP-UplinkDedicated is configured, where

$${N}_{RB}^{UL , BWP}$$

may be understood to be defined in clause 7.3.1.0. For PUSCH hopping with resource allocation type 1: N_{UL_hop} MSB bits may be used to indicate the frequency offset according to Clause 6.3 of [6, TS 38.214], where N_{UL_hop}=1 if the higher layer parameter frequencyHoppingOffsetLists contains two offset values and N_{UL_hop}=2 if the higher layer parameter frequencyHoppingOffsetLists contains four offset values.

$$⌈ {log}_{2} ( {N}_{RB}^{UL , BWP} ( {N}_{RB}^{UL , BWP} + 1 ) / 2 ) ⌉ - {N}_{UL\_hop}$$

bits may provide the frequency domain resource allocation according to Clause 6.1.2.2.2 of [6, TS 38.214, v.17.5.0. For non-PUSCH hopping with resource allocation type

$$1 : ⌈ {log}_{2} ( {N}_{RB}^{UL , BWP} ( {N}_{RB}^{UL , BWP} + 1 ) / 2 ) ⌉$$

bits may provide the frequency domain resource allocation according to Clause 6.1.2.2.2 of [6, TS 38.214, v.17.5.0].

In Clause 7.3.1.0,

$${N}_{RB}^{UL , BWP}$$

is the size of the initial UL bandwidth part. Considering that initial UL BWP may be up to 100 MHz for a regular reference UE, this does not add any constraint on the Transport Block (TB) allocation for SDT. This may be understood to be since the maximum bandwidth in NR Frequency 1 (FR1) may be understood to be 100 MHz, hence no restriction on the initial BWP may be understood to be imposed.

However, scheduling Physical Downlink Shared Channel (PDSCH) in a similar manner constraints the TB allocation, which may limit the transmission capability for Rel-18 MT-SDT.

### SUMMARY

As part of the development of embodiments herein, one or more challenges with the existing technology will first be identified and discussed.

In MT-SDT, the network may schedule DL PDSCH transmissions as provided in TS 38.212, v. 17.3.0. According to 38.212, v.17.3.0, for initial DL transmission, the scheduling may be as follows. The following information may be transmitted by means of the DCI format 1_0 with CRC scrambled by TC-RNTI. One type of information that may be transmitted by means of the DCI format 1_0 with CRC scrambled by TC-RNTI may be an identifier for DCI formats-1 bit. The value of this bit field may be always set to 1, indicating a DL DCI format. Another type of information that may be transmitted by means of the DCI format 1_0 with CRC scrambled by TC-RNTI may be frequency domain resource assignment

$$⌈ {log}_{2} ( {N}_{RB}^{DL , BWP} ( {N}_{RB}^{DL , BWP} + 1 ) / 2 ) ⌉$$

bits.

$${N}_{RB}^{DL , BWP}$$

may be understood to be the size of Control Resource Set (CORESET) 0.

For subsequent DL transmissions, the transmissions may be within the initial DL BWP which may be configured based on clause 7.3.1.0. The following information may be transmitted by means of the DCI format 1_0 with CRC scrambled by C-RNTI or CS-RNTI or MCS-C-RNTI. One type of information that may be transmitted by means of the DCI format 1_0 with CRC scrambled by C-RNTI or CS-RNTI or MCS-C-RNTI may be an identifier for DCI formats-1 bit. The value of this bit field may be always set to 1, indicating a DL DCI format. Another type of information that may be transmitted by means of the DCI format 1_0 with CRC scrambled by C-RNTI or CS-RNTI or MCS-C-RNTI may be frequency domain resource assignment.

$$⌈ {log}_{2} ( {N}_{RB}^{DL , BWP} ( {N}_{RB}^{DL , BWP} + 1 ) / 2 ) ⌉$$

bits where

$${N}_{RB}^{DL , BWP}$$

may be given by clause 7.3.1.0.

Finally, clause 7.3.1.0 may configure the initial DL BWP as follows. Determine DCI format 1_0 monitored in a common search space according to clause 7.3.1.2.1 where

$${N}_{RB}^{DL , BWP}$$

may be given by: the size of CORESET 0 if CORESET 0 is configured for the cell; and the size of initial DL bandwidth part if CORESET 0 is not configured for the cell.

The above indicates that DL MT-SDT transmissions are restricted to bandwidth of CORESET 0 until RRCRelease or RRCResume. For 30 KHz subcarrier spacing, this may be understood to mean the scheduler may allocate a maximum of up to 48 Physical Resource Blocks (PRBs) within CORESET 0 based on TS 38.213, v. 17.3.0. This limits the transport block allocation for DL subsequent transmissions significantly. This may be understood to be since the DL MT-SDT transmissions may be understood to be limited to the bandwidth of CORESET 0 or the initial DL BWP, both of which may be understood to be less than the maximum bandwidth of 100 MHz. This may lead to higher number of subsequent transmissions, which may in turn lead to larger energy consumption and increased signalling overhead.

Certain aspects of the present disclosure and their embodiments may provide solutions to these or other challenges.

It is therefore an object of embodiments herein to improve the handling of a BWP.

According to a first aspect of embodiments herein, the object is achieved by a method, performed by a wireless device. The method is for handling a bandwidth part (BWP). The wireless device operates in a wireless communications network. The wireless device obtains, a first indication. The first indication indicates a first BWP. The first BWP is different than a second BWP. The second BWP is a subset of an initial BWP. The first BWP is for transmission by a network node operating in the wireless communications network, of data to the wireless device in inactive state.

According to a second aspect of embodiments herein, the object is achieved by a method, performed by the network node. The method is for handling the BWP. The network node operates in the wireless communications network. The network node sends the first indication. The first indication indicates the first BWP. The first BWP is different than the second BWP. The second BWP is the subset of the initial BWP. The first BWP is for transmission by the network node of data to the wireless device, operating in the wireless communications network, in inactive state.

According to a third aspect of embodiments herein, the object is achieved by the wireless device, for handling the BWP. The wireless device is further configured to obtain the first indication. The first indication is configured to indicate the first BWP, different than the second BWP. The second BWP is configured to be the subset of the initial BWP. The first BWP is configured to be for transmission, by the network node configured to operate in the wireless communications network, of data to the wireless device in inactive state.

According to a fourth aspect of embodiments herein, the object is achieved by the network node, for handling the BWP. The network node is configured to operate in the wireless communications network. The network node is further configured to send the first indication. The first indication is configured to indicate the first BWP, different than the second BWP. The second BWP is configured to be the subset of the initial BWP. The first BWP is configured to be for transmission, by the network node, of data to the wireless device, configured to operate in the wireless communications network, in inactive state.

Embodiments herein provide methods that may enable the wireless device to use a larger BWP while transmitting DL data as part of MT-SDT functionality.

Embodiments herein, may be understood to support a larger BWP for DL MT-SDT transmissions which may enable reducing the total number of transmissions within the MT-SDT procedure. Reducing the signalling overhead, in turn, may result in reduced energy consumption for the wireless device.

### BRIEF DESCRIPTION OF THE DRAWINGS

Examples of embodiments herein are described in more detail with reference to the accompanying drawings, according to the following description.

FIG. 1 is a signalling diagram depicting a non-limiting example of MO-SDT baseline with subsequent transmissions, according to existing methods.

FIG. 2 is a signalling diagram depicting a non-limiting example of MT-SDT baseline with subsequent transmissions, according to existing methods.

FIG. 3 is a schematic diagram depicting an example of a wireless communications network, according to embodiments herein.

FIG. 4 is a flowchart depicting a method in a wireless device, according to embodiments herein.

FIG. 5 is a flowchart depicting a method in a network node, according to embodiments herein.

FIG. 6 is a signalling diagram depicting a non-limiting example of a method in a wireless communications network, according to embodiments herein.

FIG. 7 is a schematic block diagram illustrating an embodiment of a wireless device, according to embodiments herein.

FIG. 8 is a schematic block diagram illustrating an embodiment of a network node, according to embodiments herein.

FIG. 9 is a flowchart depicting a method in a wireless device, according to examples related to embodiments herein.

FIG. 10 is a flowchart depicting a method in a network node, according to examples related to embodiments herein.

FIG. 11 is a schematic block diagram illustrating an example of a communication system 1100 in accordance with some embodiments.

FIG. 12 is a schematic block diagram illustrating an example of a UE 1200 in accordance with some embodiments.

FIG. 13 is a schematic block diagram illustrating an example of a network node 1300 in accordance with some embodiments.

FIG. 14 is a schematic block diagram illustrating a host 1400, which may be an embodiment of the host 1116 of FIG. 11, in accordance with various aspects described herein.

FIG. 15 is a schematic block diagram illustrating an example of a virtualization environment 1500 in which functions implemented by some embodiments may be virtualized.

FIG. 16 shows a communication diagram of a host 1602 communicating via a network node 1604 with a UE 1606 over a partially wireless connection in accordance with some embodiments.

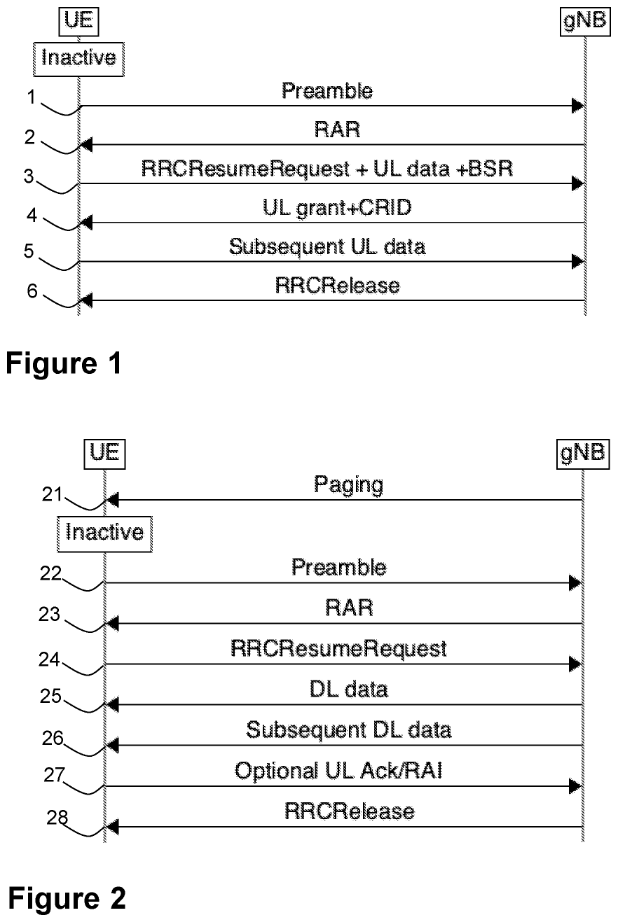

### DETAILED DESCRIPTION

Certain aspects of the present disclosure and their embodiments may provide solutions to the challenges described in the Background and Summary sections or other challenges. Embodiments herein may be generally understood to relate to initial BWP switch in MT-SDT. Particularly, embodiments herein may relate to an approach that may enable methods to configure a different BWP to the UE in INACTIVE state, techniques to switch to the new BWP, and/or methods to use the whole initial BWP for SDT transmission.

Some of the embodiments contemplated will now be described more fully hereinafter with reference to the accompanying drawings, in which examples are shown. In this section, the embodiments herein will be illustrated in more detail by a number of exemplary embodiments. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art. It should be noted that the exemplary embodiments herein are not mutually exclusive. Components from one embodiment may be tacitly assumed to be present in another embodiment and it will be obvious to a person skilled in the art how those components may be used in the other exemplary embodiments.

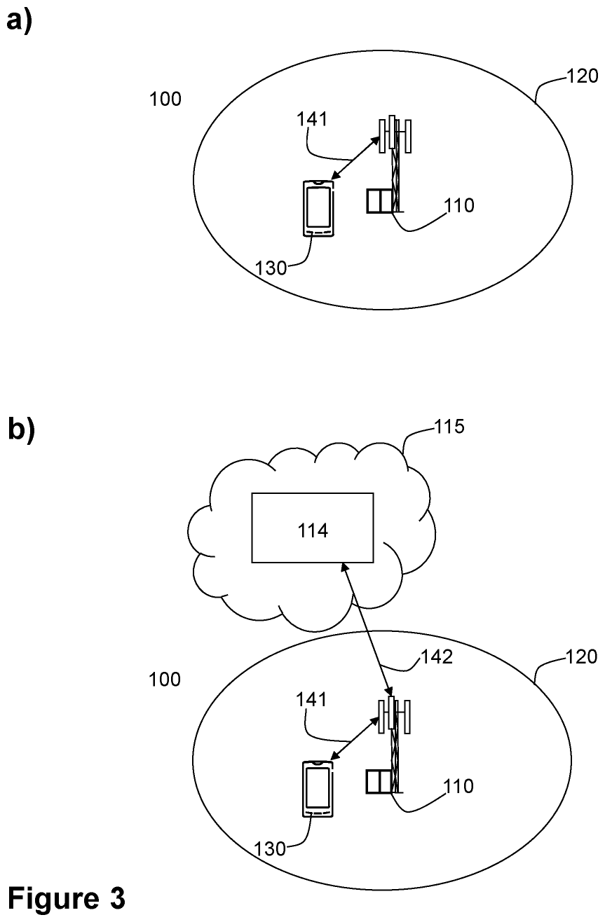

FIG. 3 depicts two non-limiting examples, in panel a) and panel b), respectively, of a wireless network or wireless communications network 100, sometimes also referred to as a wireless communications system, cellular radio system, or cellular network, in which embodiments herein may be implemented. The wireless communications network 100 may be a 5G system, 5G network, or Next Gen System. In other examples, the wireless communications network 100 may be a newer system with similar functionality. Yet in other examples, the wireless communications network 100 may in addition, support other technologies such as, for example, Long-Term Evolution (LTE), e.g., LTE for Machines (LTE-M), LTE Frequency Division Duplex (FDD), LTE Time Division Duplex (TDD), LTE Half-Duplex Frequency Division Duplex (HD-FDD), LTE operating in an unlicensed band, such as LTE Licensed-Assisted Access (LAA), enhanced eLAA (eLAA), further enhanced LAA (feLAA) and/or MulteFire. Yet in other examples, the wireless communications network 100 may further support other technologies such as, for example Wideband Code Division Multiple Access (WCDMA), Universal Terrestrial Radio Access (UTRA) TDD, Global System for Mobile communications (GSM) network, GSM/Enhanced Data Rates for GSM Evolution (EDGE) Radio Access Network (GERAN) network, Ultra-Mobile Broadband (UMB), EDGE network, network comprising any combination of Radio Access Technologies (RATs) such as e.g. Multi-Standard Radio (MSR) base stations, multi-RAT base stations etc., any 3rd Generation Partnership Project (3GPP) cellular network, WiFi networks, Worldwide Interoperability for Microwave Access (WiMax), or any cellular network or system. The wireless communications network 100 may typically support MTC, enhanced MTC (eMTC), IoT and/or NarrowBand IoT (NB-IoT). Thus, although terminology from 5G/NR and LTE may be used in this disclosure to exemplify embodiments herein, this should not be seen as limiting the scope of the embodiments herein to only the aforementioned system.

The wireless communications network 100 may comprise a plurality of network nodes, whereof a network node 110 is depicted in the non-limiting example of FIG. 3. The network node 110 is a radio network node. That is, a transmission point such as a radio base station, for example a gNB, or any other network node with similar features capable of serving a user equipment, such as a wireless device or a machine type communication device, in the wireless communications network 100. In some examples, such as that depicted in FIG. 3 b, the network node 110 may be a distributed node, and may partially perform its functions in collaboration with a virtual node 114 in a cloud 115. The network node 110 may be directly connected to one or more core networks, e.g., to one or more network nodes in the one or more core networks.

The wireless communications network 100 may cover a geographical area, which in some embodiments may be divided into cell areas, wherein each cell area may be served by a radio network node, although, one radio network node may serve one or several cells. In the example of FIG. 3, the network node 110 serves a cell 120. The network node 110 may be of different classes, such as, e.g., macro base station, home base station or pico base station, based on transmission power and thereby also cell size. In some examples, the network node 110 may serve receiving nodes with serving beams. The network node 100 may support one or several communication technologies, and its name may depend on the technology and terminology used.

A plurality of wireless devices may be located in the wireless communication network 100, whereof a wireless device 130, is depicted in the non-limiting example of FIG. 3. The wireless device 130 comprised in the wireless communications network 100 may be a wireless communication device such as a User Equipment (UE), e.g., 5G UE or nUE, which may also be known as e.g., mobile terminal, wireless terminal and/or mobile station, a mobile telephone, cellular telephone, or laptop with wireless capability, just to mention some further examples. The wireless device 130 may be, for example, portable, pocket-storable, hand-held, computer-comprised, or a vehicle-mounted mobile device, enabled to communicate voice and/or data, via the RAN, with another entity, such as a server, a laptop, a Personal Digital Assistant (PDA), or a tablet, Machine-to-Machine (M2M) device, a sensor, IoT device, NB-IoT device, device equipped with a wireless interface, such as a printer or a file storage device, modem, or any other radio network unit capable of communicating over a radio link in a communications system. The wireless device 130 comprised in the wireless communications network 100 may be enabled to communicate wirelessly in the wireless communications network 100. The communication may be performed e.g., via a RAN, and possibly the one or more core networks, which may be comprised within the wireless communications network 100.

The wireless device 130 may be configured to communicate within the wireless communications network 100 with the network node 110 over a first link 141, e.g., a radio link. The network node 110 may be configured to communicate within the wireless communications network 100 with the virtual network node 144 over a second link 142, e.g., a radio link or a wired link.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

In general, the usage of “first” and/or “second” herein may be understood to be an arbitrary way to denote different elements or entities, and may be understood to not confer a cumulative or chronological character to the nouns they modify, unless otherwise noted, based on context.

Several embodiments are comprised herein. It should be noted that the examples herein are not mutually exclusive. Components from one embodiment may be tacitly assumed to be present in another embodiment and it will be obvious to a person skilled in the art how those components may be used in the other exemplary embodiments.

More specifically, the following are embodiments related to a wireless device, such as the wireless device 130, e.g., a 5G UE, nUE or a UE, and embodiments related to a network node, such as the network node 110, e.g., a gNB.

Some embodiments herein will now be further described with some non-limiting examples, which may be combined with the embodiments just described.

In the following description, any reference to a/the UE, or simply “UE” may be understood to equally refer the wireless device 130; any reference to a/the gNB and/or a/the network may be understood to equally refer to the network node 110; any reference to a/the “cell” may be understood to equally refer to the cell 120.

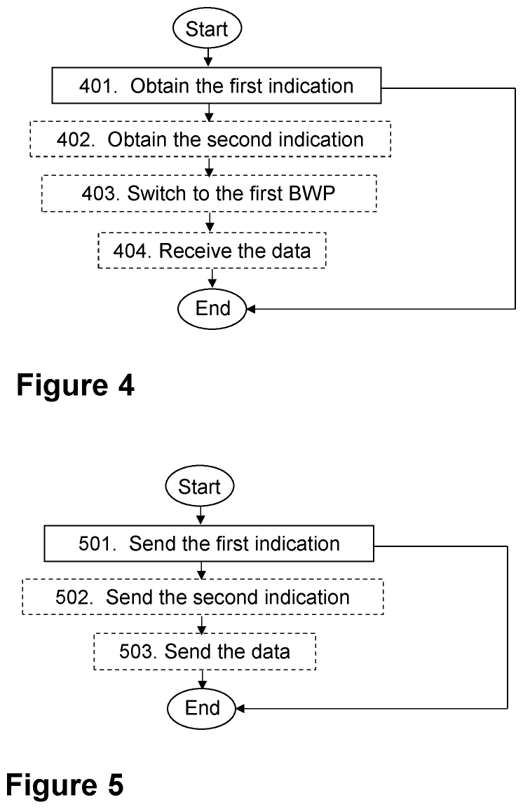

Embodiments of a method, performed by a wireless device, such as the wireless device 130, will now be described with reference to the flowchart depicted in FIG. 4. The method may be understood to be for handling a bandwidth part (BWP). The wireless device 130 operates in a wireless communications network, such as the wireless communications network 100. The method may be understood to be computer-implemented.

In some embodiments, the wireless communications network 100 may support, or operate in, New Radio (NR).

The method may comprise one or more of the following actions. In particular examples, the method may comprise Action 401. In some embodiments, all the actions may be performed. It should be noted that the examples herein may be not mutually exclusive. One or more embodiments may be combined, where applicable. Components from one embodiment may be tacitly assumed to be present in another embodiment and it will be obvious to a person skilled in the art how those components may be used in the other exemplary embodiments. All possible combinations are not described to simplify the description. A non-limiting example of the method performed by the wireless device 130 is depicted in FIG. 4. In FIG. 4 optional actions in some embodiments may be represented with dashed lines. In some embodiments, the actions may be performed in a different order than that depicted FIG. 4.

### Action 401

In this Action 401, the wireless device 130 obtains a first indication.

The first indication indicates a first BWP. The first BWP is different than a second BWP. The second BWP is a subset of an initial BWP, e.g., up to 48 Physical Resource Blocks (PRBs) within CORESET 0. The first BWP may therefore be also referred to herein as a new BWP.

The first BWP is for transmission by a network node such as the network node 110, of data to the wireless device 130 in inactive state. In some examples, the indication may further indicate the first BWP is for transmission by a network node such as the network node 110, of data to the wireless device 130 in inactive state. That is, the transmission of the data is in inactive state.

A size of a buffer comprising the data may be smaller than a threshold. That is, the data may be small data, e.g., an SDT. In some examples, the data may be configured for SDT, e.g., MT-SDT. That is, the transmission may be an SDT.

According to the foregoing, the first indication may be understood to configure the wireless device 130 to use the first BWP for MT-SDT. The first BWP may be understood to be a different BWP than the BWP within the initial BWP that may be configured at the wireless device 130 for SDT operation. That is, the first BWP may be understood to be a new BWP.

There may be different methods to configure a different BWP for the wireless device 130.

Obtaining may comprise receiving, e.g., via the first link 141, from the network node 110 or another network node, or device, or retrieving, e.g., from a memory.

### Different BWP Configuration in RRCRelease

In one first group of examples, the configuration of a different BWP, such as the first BWP, may be done in RRCRelease, e.g., as part of the SDT configuration. The new BWP, that is, the first BWP, may be applicable for SDT UEs, such as the wireless device 130, where no cell reselection may be involved. Accordingly, in some embodiments, the obtaining in this Action 401 of the first indication may be at RRCRelease.

In one sub-example, the new BWP may be a dedicated configuration. Accordingly, in some embodiments, the obtaining in this Action 401 of the first indication may be via a dedicated configuration.

In some embodiments, the obtaining in this Action 401 of the first indication may be via an information element (IE) comprised in an SDT configuration. Particularly, in some embodiments, the obtaining in this Action 401 of the first indication may be via a cg-SDT-ConfigBWP-DL IE comprised in the SDT configuration. In one example, this may involve adding a cg-SDT-ConfigBWP-DL Information Element (IE), and/or Normal Uplink (NUL), Supplementary Uplink (SUL) specific IEs as well, in addition to cg-SDT-ConfigInitialBWP-DL-r17 IE within SDT-CG-Config-r17. For example:

SDT-CG-Config-r17 ::= OCTET STRING (CONTAINING SDT-MAC-PHY-CG-Config-r17)

| | |
|---|---|
| SDT-MAC-PHY-CG-Config-r17 ::= | SEQUENCE { |

```
  -- CG-SDT specific configuration
  -- FFS on BSR configuration (e.g. i.e. for the FFS on the logicalChannelSR-DelayTimer)
  -- FFS on delta signalling (We need to clarify how this works, for instance, whether initial BWP dedicated can be considered as
  -- baseline to enable delta configuration or not etc).
  cg-SDT-Config-LCH-restrictionToAddModList-r17 SEQUENCE (SIZE(1..maxLC-ID)) OF CG-SDT-Config-LCH-restriction-r17 OPTIONAL,
  -- Need N
```

| cg-SDT-Config-LCH-restrictionToReleaseList-r17 SEQUENCE (SIZE(1..maxLC-ID)) OF LogicalChannelIdentity | | OPTIONAL, -- Need N |
|---|---|---|
| cg-SDT-Config-Initial-BWP-NUL-r17 | SetupRelease {BWP-Uplink-Dedicated-SDT-r17} | OPTIONAL, -- Need M |
| cg-SDT-Config-Initial-BWP-SUL-r17 | SetupRelease {BWP-Uplink-Dedicated-SDT-r17} | OPTIONAL, -- Need M |
| cg-SDT-Config-Initial-BWP-DL-r17 | BWP-Downlink-Dedicated-SDT-r17 | OPTIONAL, -- Need M |
| cg-SDT-Config-BWP-DL. | BWP-Downlink-SDT-r17 | OPTIONAL, -- Need M |
| cg-SDT-TimeAlignmentTimer-r17 | TimeAlignmentTimer | OPTIONAL, -- Need M |
| cg-SDT-RSRP-ThresholdSSB-r17 | RSRP-Range | OPTIONAL, -- Need M |
| cg-SDT-TA-ValiditationConfig-r17 | SetupRelease { CG-SDT-TA-ValiditationConfig-r17 } | OPTIONAL, -- Need M |

...
}

### SDT-MAC-PHY-CG-Config Field Descriptions

cg-SDT-ConfigBWP-DL
Downlink BWP configuration for CG-SDT. This configuration may be valid for a RA-SDT UE as well if the UE does
not undergo cell reselection.

In the above, LCH may be understood to indicate Logical Channel. RSRP may be understood as Received Signal Reference Power.

In some embodiments, the obtaining in this Action 401 of the first indication may be via a cg-SDT-ConfigInitialBWP-DL IE comprised in the SDT configuration. In another example, the existing cg-SDT-ConfigInitialBWP-DL IE description may be modified to include dedicated BWP. The current definition of cg-SDT-ConfigInitialBWP-DL IE may be understood to allow dedicated BWP configuration. However, the description of this IE in TS 38.331, v 17.4.0 currently restricts operation to initial BWP.

In a second group of examples, this may be an SDT-specific common BWP configuration that the UE may switch to after it may receive the initial DL data as part of Message 4. In some embodiments, the obtaining in this Action 401 of the first indication may be via a specific common BWP configuration. In particular embodiments, the obtaining in this Action 401 of the first indication may be via the specific common BWP configuration that the wireless device 130 may be enabled to switch to after receiving an initial transmission of data within a random access procedure, as part of message 4.

In this example, the MT-SDT configuration in RRCRelease may look as follows:

RRCRelease message

| | |
|---|---|
| RRCRelease ::= | SEQUENCE { |
| rrc-TransactionIdentifier | RRC-TransactionIdentifier, |
| criticalExtensions | CHOICE { |
| rrcRelease | RRCRelease-IEs, |
| criticalExtensionsFuture | SEQUENCE { } |

}
}
<omitted text>

| SuspendConfig ::= | SEQUENCE { | |
|---|---|---|
| fullI-RNTI | I-RNTI-Value, | |
| shortI-RNTI | ShortI-RNTI-Value, | |
| ran-PagingCycle | PagingCycle, | |
| ran-NotificationAreaInfo | RAN-NotificationAreaInfo | OPTIONAL, -- Need M |
| t380 | PeriodicRNAU-TimerValue | OPTIONAL, -- Need R |

| | |
|---|---|
| nextHopChainingCount | NextHopChainingCount, |

```
      ...,
      [[
```

| | | |
|---|---|---|
| sl-UEIdentityRemote-r17 | RNTI-Value | OPTIONAL, -- Cond L2RemoteUE |
| sdt-Config-r17 | SetupRelease { SDT-Config-r17 } | OPTIONAL, -- Need M |
| srs-PosRRC-Inactive-r17 | SetupRelease { SRS-PosRRC-Inactive-r17 } | OPTIONAL, -- Need M |
| ran-ExtendedPagingCycle-r17 | ExtendedPagingCycle-r17 | OPTIONAL, -- Cond RANPaging |
| mtsdt-BWP-r18 | SetupRelease { BWP-DownlinkCommon-SDT-r18 } | OPTIONAL -- Need M |

]]
}
<omitted text>

| BWP-DownlinkCommon-SDT-r18 ::= | SEQUENCE { | |
|---|---|---|
| genericParameters | BWP, | |
| pdcch-ConfigCommon | SetupRelease { PDCCH-ConfigCommon } | OPTIONAL, -- Need M |
| pdsch-ConfigCommon | SetupRelease { PDSCH-ConfigCommon } | OPTIONAL, -- Need M |

}
<omitted text>

In the above, I-RNTI may be understood to indicate Inactive RNTI. SRS may be understood to indicate Sounding Reference Signal.

It may be understood that in embodiments and examples herein, a reference to Release 18 (r18) or version 18 (v18) may be understood to be for non-limiting illustration purposes. Any embodiments and examples referring to r18 may be understood to be equally valid for any other subsequent release with similar functionality.

Accordingly, in some embodiments, the obtaining in this Action 401 of the first indication may be via an mtsdt-BWP IE, e.g., via an mtsdt-BWP-r18 IE or an mtsdt-BWP IE of a subsequent release of similar functionality.

In one example, the new mtsdt-BWP-r18 may be BWP-DownlinkCommon-SDT-r18 which may contain only the common parameters of a downlink BWP similar with BWP-DownlinkCommon, or mtsdt-BWP-r18 may be BWP-Downlink-SDT-r18 which may contain both common and UE dedicated parameters of a downlink BWP similar with BWP-Downlink.

Accordingly, in some embodiments, the obtaining in this Action 401 of the first indication may be via the mtsdt-BWP, wherein the mtsdt-BWP comprises only common parameters of a downlink BWP e.g., via the mtsdt-BWP-r18, wherein the mtsdt-BWP-r18 comprises only common parameters of a downlink BWP or an mtsdt-BWP wherein the mtsdt-BWP comprises only common parameters of a downlink BWP of a subsequent release of similar functionality.

Common parameters may be understood as parameters which may be provided in SI and may be obtained/configured to all wireless devices in a cell.

In particular embodiments, the obtaining in this Action 401 of the first indication may be via the BWP-Downlink-SDT, comprising one of: a) common parameters and b) common parameters and dedicated parameters, e.g., via the BWP-Downlink-SDT-r18, comprising one of: a) common parameters and b) common parameters and dedicated parameters or an via the BWP-Downlink-SDT, comprising one of: a) common parameters and b) common parameters and dedicated parameters of a subsequent release of similar functionality.

Dedicated parameters may be understood as parameters which may be configured by, e.g., the RRCRelease message, to a single wireless device, and which may be valid in the cell where the wireless device, e.g., the wireless device 130, may have been released. The same dedicated parameters/configuration may be applied to several wireless devices.

Moreover, in case mtsdt-BWP-r18 has UE dedicated configurations, a different CORESET and/or search space may be adopted to MT-SDT/MO-SDT which may make the Physical Downlink Control Channel (PDCCH) performance more robust and give a better PDCCH resource utilization with non-SDT transmissions. Also Non Cell Defining Synchronization Signal Block (NCD-SSB) may be configured in the UE dedicated configurations for SDT. An NCD-SSB may be understood as a reference signal, Synchronization Signal Block (SSB), which may not contain any cell identifier or information of SI.

Accordingly, in some embodiments, the obtaining in this Action 401 of the first indication may be via the Mtdst-BWP comprising dedicated parameters, wherein the dedicated parameters may comprise at least one of: a different CORESET than the second BWP, a different search space than the second BWP and a NCD-SSB. A non-limiting example may be via the Mtdst-BWP-r18 comprising dedicated parameters, wherein the dedicated parameters comprise at least one of: a different CORESET than the second BWP, a different search space than the second BWP and a NCD-SSB or via the Mtdst-BWP comprising dedicated parameters, wherein the dedicated parameters comprise at least one of: a different CORESET than the second BWP, a different search space than the second BWP and a NCD-SSB of a subsequent release of similar functionality.

A search space may be understood as time and frequency resources where a wireless device, such as the wireless device 130, may monitor for PDCCH transmissions and the format of the PDCCH transmission.

In one sub-group of examples, the MO-SDT may also use a different uplink BWP, where the corresponding uplink BWP may be configured in a similar way, or an uplink BWP relationship may be defined with a corresponding downlink BWP when MT-SDT may be simultaneously processing with MO-SDT.

In some embodiments, the obtaining in this Action 401 of the first indication may be via System Information (SI).

In some embodiments, at least one of may apply: a) a size of a buffer comprising the data is smaller than a threshold, b) the data is a small data transmission, SDT, c) the data may be configured for SDT, d) the obtaining 401 of the first indication may be from the network node 110, e) the first BWP may be applicable as long as cell reselection may be not performed, f) the first indication may indicate a first identifier of the first BWP and a second identifier of a CORESET, and the first BWP and the CORESET may be indicated in SI, and g) the first BWP may be a downlink BWP corresponding to an uplink BWP used for Mobile Originated Small Data Transmission (MO-SDT).

In one sub-group of examples, when the RRCRelease message may be used to signal the use of a different DL-BWP, the RRCRelease message may only contain the BWP-Identifier (Id) and CORESET-ID of the DL BWP that the wireless device 130 may use to receive DL transmissions. In this case this DL BWP and CORESET may be configured in SI.

### Different BWP Configuration in System Information Block 1 (SIB1)

In some embodiments, the obtaining in this Action 401 of the first indication may be via System Information Block 1 (SIB1).

As a different group of examples, SDT-specific BWP configuration may be provided via SIB1.

In some embodiments, the obtaining in this Action 401 of the first indication may be via a ServingCellConfig IE received in SI.

An SDT specific BWP may be defined as part of ServingCellConfig IE or this may be part of nonCriticalExtension and may be cell-specific. For example, SIB1 may be configured to include an SDT-specific BWP as follows.

SIB1 message

-- ASN1START
-- TAG-SIB1-START

| SIB1 ::= | SEQUENCE { | |
|---|---|---|
| cellSelectionInfo | SEQUENCE { | |
| q-RxLevMin | Q-RxLevMin, | |
| q-RxLevMinOffset | INTEGER (1..8) | OPTIONAL, -- Need S |
| q-RxLevMinSUL | Q-RxLevMin | OPTIONAL, -- Need R |
| q-QualMin | Q-QualMin | OPTIONAL, -- Need S |
| q-QualMinOffset | INTEGER (1..8) | OPTIONAL -- Need S |
| } | | OPTIONAL, -- Cond Standalone |
| cellAccessRelatedInfo | CellAccessRelatedInfo, | |
| connEstFailureControl | ConnEstFailureControl | OPTIONAL, -- Need R |
| si-SchedulingInfo | SI-SchedulingInfo | OPTIONAL, -- Need R |
| servingCellConfigCommon | ServingCellConfigCommonSIB | OPTIONAL, -- Need R |
| ims-EmergencySupport | ENUMERATED {true} | OPTIONAL, -- Need R |
| eCallOverIMS-Support | ENUMERATED {true} | OPTIONAL, -- Need R |
| ue-TimersAndConstants | UE-TimersAndConstants | OPTIONAL, -- Need R |
| uac-BarringInfo | SEQUENCE { | |
| uac-BarringForCommon | UAC-BarringPerCatList | OPTIONAL, -- Need S |
| uac-BarringPerPLMN-List | UAC-BarringPerPLMN-List | OPTIONAL, -- Need S |

| | |
|---|---|
| uac-BarringInfoSetList | UAC-BarringInfoSetList, |

uac-AccessCategory1-SelectionAssistanceInfo CHOICE {

| plmnCommon | UAC-AccessCategory1-SelectionAssistanceInfo, | |
|---|---|---|
| individualPLMNList | SEQUENCE (SIZE (2..maxPLMN)) OF UAC-AccessCategory1-SelectionAssistanceInfo | |
| } | | OPTIONAL -- Need S |
| } | | OPTIONAL, -- Need R |
| useFullResumeID | ENUMERATED {true} | OPTIONAL, -- Need R |
| lateNonCriticalExtension | OCTET STRING | OPTIONAL, |
| nonCriticalExtension | SIB1-v1610-IEs | OPTIONAL |

}
<omitted text>

| SIB1-v1700-IEs ::= | SEQUENCE { | |
|---|---|---|
| hsdn-Cell-r17 | ENUMERATED {true} | OPTIONAL, -- Need R |
| uac-BarringInfo-v1700 | SEQUENCE { | |
| uac-BarringInfoSetList-v1700 | UAC-BarringInfoSetList-v1700 | |
| } | | OPTIONAL, -- Cond MINT |
| sdt-ConfigCommon-r17 | SDT-ConfigCommonSIB-r17 | OPTIONAL, -- Need R |
| redCap-ConfigCommon-r17 | RedCap-ConfigCommonSIB-r17 | OPTIONAL, -- Need R |
| featurePriorities-r17 | SEQUENCE { | |
| redCapPriority-r17 | FeaturePriority-r17 | OPTIONAL, -- Need R |
| slicingPriority-r17 | FeaturePriority-r17 | OPTIONAL, -- Need R |
| msg3-Repetitions-Priority-r17 | FeaturePriority-r17 | OPTIONAL, -- Need R |
| sdt-Priority-r17 | FeaturePriority-r17 | OPTIONAL -- Need R |
| } | | OPTIONAL, -- Need R |
| si-SchedulingInfo-v1700 | SI-SchedulingInfo-v1700 | OPTIONAL, -- Need R |
| hyperSFN-r17 | BIT STRING (SIZE (10)) | OPTIONAL, -- Need R |
| eDRX-AllowedIdle-r17 | ENUMERATED {true} | OPTIONAL, -- Need R |
| eDRX-AllowedInactive-r17 | ENUMERATED {true} | OPTIONAL, -- Cond EDRX-RC |
| intraFreqReselectionRedCap-r17 | ENUMERATED {allowed, notAllowed} | OPTIONAL, -- Need S |
| cellBarredNTN-r17 | ENUMERATED {barred, notBarred} | OPTIONAL, -- Need S |

[symbol]

[symbol]

[symbol]

| | | |
|---|---|---|
| nonCriticalExtension | SIB1-v18-IEs | OPTIONAL |

}
SIB1-v18-IEs ::= SEQUENCE {

| | | |
|---|---|---|
| mtsdt-ConfigCommon-r18 | BWP-DownlinkCommon-SDT-r18 | OPTIONAL, -- Need R |
| nonCriticalExtension | SEQUENCE { } | OPTIONAL |

}
<omitted text>

Alternatively, configuration for a new BWP, such as the first BWP, may be done over MT-SDT paging message.

Accordingly, in some embodiments, the obtaining in this Action 401 of the first indication may be over a paging message. Particularly, in some embodiments, the obtaining in this Action 401 of the first indication may be over an MT-SDT paging message. In one option, the paging message may contain the BWP-Id and CORESET-ID that the wireless device 130 may use to receive DL transmissions. In this option, the BWP and CORESET may be configured in SI.

According to the embodiments and examples just described, in some embodiments, the obtaining in this Action 401 of the first indication may be one of: a) at RRCRelease, b) via a dedicated configuration, c) via an IE comprised in an SDT configuration, d) via a cg-SDT-ConfigBWP-DL IE comprised in the SDT configuration, e) via a cg-SDT-ConfigInitialBWP-DL IE comprised in the SDT configuration, f) via a specific common BWP configuration, g) via the specific common BWP configuration that the wireless device 130 is enabled to switch to after receiving an initial transmission of data within a random access procedure, as part of message 4, h) via an mtsdt-BWP IE, i) via the mtsdt-BWP, wherein the mtsdt-BWP comprises only common parameters of a downlink BWP, j) via the BWP-Downlink-SDT, comprising one of: a) common parameters and b) common parameters and dedicated parameters, k) via the Mtdst-BWP comprising dedicated parameters, wherein the dedicated parameters comprise at least one of: a different CORESET than the second BWP, a different search space than the second BWP and a Non Cell Defining Synchronization Signal Block, NCD-SSB, l) via SI, m) via System Information Block 1 (SIB1), n) via a ServingCellConfig IE received in SI, o) over a paging message, and p) over a MT-SDT paging message.

### Methods to Use Whole Initial BWP for SDT Transmission

As described in in the Summary Section, MT-SDT transmission may be restricted to the bandwidth of CORESET 0 in existing methods. In one example of embodiments herein, the restriction to the bandwidth of CORESET 0 may be removed for MT-SDT, where MT-SDT transmission may allocate a maximum of up to the whole initial DL BWP.

In some embodiments, at least one of the following may apply: a) the subset of the initial BWP may be a bandwidth of CORESET 0, b) the first indication may indicate a restriction of the initial BWP to CORESET 0 is removed or lifted, and c) the first BWP may have an allocation of up to the whole initial BWP.

In this case, a different downlink BWP apart from initial DL BWP may not be needed and no BWP switching may also not be needed.

By the wireless device 130 obtaining the first indication in this Action 401, embodiments herein may enable the wireless device 130 to use a larger BWP while receiving DL data as part of MT-SDT functionality. This may be understood to be because the first BWP is different than the second BWP, which is a subset of the initial BWP, e.g., up to 48 Physical Resource Blocks (PRBs) within CORESET 0. Embodiments herein, may therefore be understood to support a larger BWP for DL MT-SDT transmissions, which may enable reducing the total number of transmissions within the MT-SDT procedure. Reducing the signalling overhead, in turn, may result in reduced energy consumption for the wireless device 130.

In some embodiments, the method may further comprise one or more of the following actions.

### Action 402

In this Action 402, the wireless device 130 may obtain a second indication.

The obtaining in this Action 402 may be after having obtained the first indication.

Obtaining may comprise receiving, e.g., via the first link 141, from the network node 110 or another network node, or device, or retrieving, e.g., from a memory.

The second indication may indicate to switch to the first BWP.

### Techniques to Switch to a New BWP

In legacy UEs, BWP switching in CONNECTED mode may be based on one of the following alternatives: over DCI, based on RRC signaling, based on bwp-InactivityTimer, initiation from the MAC entity.

The obtaining in this Action 402 of the second indication may be one of: a) from the network node 110, b) over RRC signalling, c) while the wireless device 130 remains in inactive state, d) by expiration of a timer, e) via a MAC Control Element (CE), and f) via a pre-configuration.

To bring one or multiple of these approaches to fit the SDT narrative, minor configuration changes may need to be proposed.

### BWP Switching Using DCI

According to one option, the obtaining in this Action 402 of the second indication may be from the network node 110. In some examples, the second indication may be DCI. In some embodiments, at least one of the following may apply: a) the switching, as described in the next Action 403, may be supported by a DCI format selected from DCI 0_0 and DCI 1_0, and b) the second indication may comprise an indicator of the first BWP to switch to.

Currently, BWP switching may be supported by non-fallback formats DCI 0_1 and DCI 1_1. However, MT-SDT UEs currently support only fallback DCI formats DCI 0_0 and DCI 1_0. Therefore, in one example, the BWP switching support may be introduced to fallback DCI formats by introducing a Bandwidth part Indicator field. The field may contain an index that may point to the BWP to switch to, based on the BWP configured using one of the techniques proposed in the Section entitled “Methods to configure a different BWP for the UE”.

As part of the above group of examples, a PDCCH scheduling initial DL data may be configured with a BWP indicator field which may instruct the wireless device 130 to switch to the new BWP, that is the first BWP, for its continued operation. This may be understood to mean that the wireless device 130 may continue its subsequent transmissions over this newly active BWP.

### Based on RRC Signaling

As stated earlier, the obtaining in this Action 402 of the second indication may be from the network node 110. According to one option, the obtaining in this Action 402 of the second indication may be over RRC signalling. According to yet another option, the obtaining in this Action 402 of the second indication may be while the wireless device 130 may remain in inactive state.

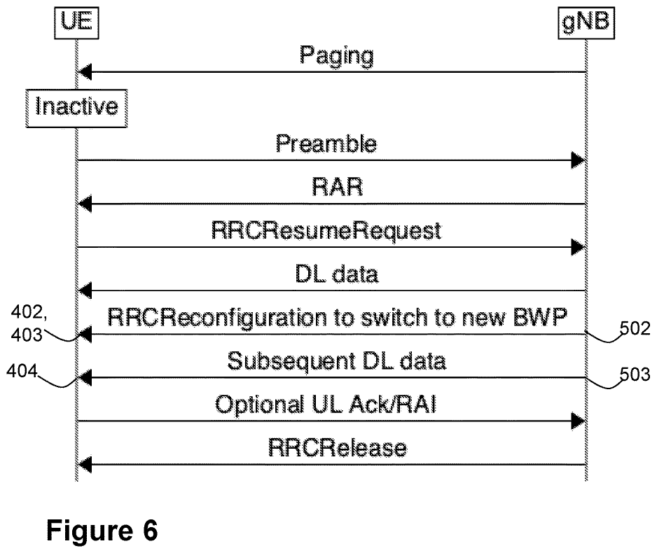

RRCReconfiguration may support defining and switching the wireless device 130 to a new BWP, such as the first BWP, in CONNECTED mode. In one example, an RRCReconfiguration may be triggered for the wireless device 130 while the wireless device 130 may remain in the INACTIVE mode as shown in FIG. 6. That is, while the wireless device 130 may be in inactive state, and after having been paged by the network node 110, sent a preamble to the network node 110, received a Random Access Response (RAR) from the network node 110, and sent an RRCResumeRequest to the network node 110.

In one example, signaling of RRCReconfiguration to switch to a new BWP, such as the first BWP, may be transmitted together with the first DL data, when subsequent DL transmission may have to be scheduled. After receiving the second indication, the wireless device 130 may then receive the subsequent DL data from the network node 110, send an optional UL Acknowledgement (Ack)/RAI to the network node 110, and receive an RRCRelease from the network node 110.

### Based on BWP-Timer

According to yet another option, the obtaining in this Action 402 of the second indication may be while the wireless device 130 may remain in inactive state, e.g., based on a timer, such as a BWP-Timer.

In one group of examples, a new SDT specific BWP-Timer may be defined to trigger switching after Message 4 or MsgB or initial transmission on a CG-SDT resource. For example, this timer may be triggered upon MT-SDT paging and stopped upon the reception of the first DL data.

### MAC Entity-Based Triggering

As stated earlier, the obtaining in this Action 402 of the second indication may be from the network node 110. In one group of examples, a MAC CE may be defined to trigger BWP switch. According to this option, the obtaining in this Action 402 of the second indication may be via a MAC Control Element (CE). This may be a fixed/variable MAC CE which may be multiplexed with the initial or the subsequent DL data. The wireless device 130 may switch to the new BWP, that is, the first BWP, upon the reception of this MAC CE. The new MAC CE may indicate the BWP-Id and CORESET-ID that the wireless device 130 may be required to use to receive DL transmissions. This MAC CE may be transmitted any time after contention resolution, Msg4 in the 4-step RA procedure or MsgB in the 2-step RA procedure, or be part of Msg4 or MsgB. Before reception of this MAC CE, the wireless device 130 may use the initial BWP and CORESET 0 as in MO-SDT. The new MAC CE may be transmitted after Msg4 or MsgB if e.g., new DL data arrives in the network node 110, and the network node 110 determines that it may be beneficial to switch DL BWP. The use of the MAC CE may be flexible in the sense that it may switch DL BWP for the UEs where and when the need may arise. The use of this MAC CE may also require that the BWP and CORESET are configured in SI.

### Based on Specification

According to yet another option, the obtaining in this Action 402 of the second indication may be via a pre-configuration, that is, based on specification.

In one example, the switch to the new BWP, that is, the first BWP, may always be performed when the SDT specific BWP may be configured in SI or in the RRCRelease. It may be specified when the switch may be performed, e.g., after Msg4 or MsgB or after initial transmission on a CG-SDT resource. The switch may also be conditional on the Data Radio Bearer (DRB) or priority of the DRB. This may be understood to mean that if the wireless device 130 receives DL data on a specific DRB, it may switch BWP after Msg4 or MsgB or after initial transmission on a CG-SDT resource.

In some embodiments, the wireless device 130 may refrain from switching BWP. The wireless device 130, e.g., in some of these embodiments may obtain a frequency domain resource allocation of up to the entire initial DL BWP while performing small data transmissions.

By obtaining the second indication indicating to switch to the first BWP in this Action 402, the wireless device 130 may be enabled to switch to the larger BWP to receive the DL data from the network node 110, and therefore enable to reduce the total number of transmissions within the MT-SDT procedure. Reducing the signalling overhead, in turn, may result in reduced energy consumption for the wireless device 130.

### Action 403

In this Action 403, the wireless device 130 may switch to the first BWP.

The switching in this Action 403 may be based on the received second indication.

As stated earlier, in some embodiments, at least one of the following may apply: a) the switching in this Action 403 may be supported by a DCI format selected from DCI 0_0 and DCI 1_0, and b) the second indication may comprise an indicator of the first BWP to switch to.

By switching to the first BWP in this Action 403, the wireless device 130 may be enabled to receive the DL data from the network node 110 over the larger first BWP, and therefore enable to reduce the total number of transmissions within the MT-SDT procedure. Reducing the signalling overhead, in turn, may result in reduced energy consumption for the wireless device 130.

### Action 404

In this Action 404, the wireless device 130 may receive the data. As stated earlier, the data may be SDT.

The receiving in this Action 404 may be from the network node 110. As stated earlier, the data may be MT-SDT.

The receiving in this Action 404 may be performed, e.g., via the first link 141.

The receiving in this Action 404 may be in the first BWP. The receiving in this Action 404 may be based on the obtained first indication.

The data may be received from the network node 110 in the first BWP, after having switched to the first BWP.

By receiving the data in inactive state in the first BWP in this Action 404, the wireless device 130 may be enabled to receive the DL data from the network node 110 over the larger first BWP, and therefore enable to reduce the total number of transmissions within the MT-SDT procedure. Reducing the signalling overhead, in turn, may result in reduced energy consumption for the wireless device 130.

Embodiments of a method, performed by a network node, such as the network node 110 will now be described with reference to the flowchart depicted in FIG. 5. The method may be understood to be for handling the BWP. The network node 110 operates in a wireless communications network, such as the wireless communications network 100. The method may be understood to be computer-implemented.

In some embodiments, the wireless communications network 100 may support New Radio (NR).

The method may comprise one or more of the following actions. In a particular non-limiting example, Action 501 may be performed. In some embodiments, all the actions may be performed. It should be noted that the examples herein may be not mutually exclusive. One or more embodiments may be combined, where applicable. Components from one embodiment may be tacitly assumed to be present in another embodiment and it will be obvious to a person skilled in the art how those components may be used in the other exemplary embodiments. All possible combinations are not described to simplify the description. A non-limiting example of the method performed by the network node 110 is depicted in FIG. 5. In FIG. 5, optional actions in some embodiments may be represented with dashed lines. In some embodiments, the actions may be performed in a different order than that depicted FIG. 5.

The detailed description of some of the following corresponds to the same references provided above, in relation to the actions described for the wireless device 130 and will thus not be repeated here to simplify the description. For example, the data may be SDT.

### Action 501

In this Action 501, the network node 110 sends the first indication.

The sending in this Action 501 may be performed, e.g., via the first link 141.

The first indication indicates the first BWP. The first BWP is different than the second BWP. The second BWP is the subset of the initial BWP, e.g., up to 48 Physical Resource Blocks (PRBs) within CORESET 0.

The first BWP is for transmission by a network node such as the network node 110, of data to the wireless device 130, operating in the wireless communications network 100, in inactive state. In some examples, the indication may further indicate the first BWP is for transmission. The transmission is, e.g., by the network node such as the network node 110, of data to the wireless device 130. The transmission is in inactive state.

The size of the buffer comprising the data may be smaller than the threshold. That is, the data may be small data, e.g., an SDT. In some examples, the data may be configured for SDT, e.g., MT-SDT. That is, the transmission may be an SDT.

In some embodiments, the sending in this Action 501 of the first indication may be one of: a) at RRCRelease, b) via the dedicated configuration, c) via the IE comprised in the SDT configuration, d) via the cg-SDT-ConfigBWP-DL IE comprised in the SDT configuration, e) via the cg-SDT-ConfigInitialBWP-DL IE comprised in the SDT configuration, f) via the specific common BWP configuration, g) via the specific common BWP configuration that the wireless device 130 is enabled to switch to after receiving the initial transmission of data within the random access procedure, as part of message 4, h) via the mtsdt-BWP IE, e.g., the mtsdt-BWP-r18 IE, i) via the mtsdt-BWP, wherein the mtsdt-BWP comprises only, common parameters of the downlink BWP, e.g., the via the mtsdt-BWP-r18, wherein the mtsdt-BWP-r18 comprises only, common parameters of the downlink BWP, j) via the BWP-Downlink-SDT, e.g., the BWP-Downlink-SDT-r18, comprising one of: a) common parameters and b) common parameters and dedicated parameters, k) via the Mtdst-BWP, e.g., the Mtdst-BWP-r18, comprising dedicated parameters, wherein the dedicated parameters comprise at least one of: the different CORESET than the second BWP, the different search space than the second BWP and the NCD-SSB, l) via SI, m) via SIB1, n) via the ServingCellConfig IE received in SI, o) over the paging message, and p) over the MT-SDT paging message.

As stated earlier, it may be understood that in embodiments and examples herein, a reference to Release 18 (r18) or version 18 (v18) may be understood to be for non-limiting illustration purposes. Any embodiments and examples referring to r18 may be understood to be equally valid for any other subsequent release with similar functionality.

In some embodiments, at least one of the following may apply: a) the subset of the initial BWP may be a bandwidth of CORESET 0, b) the first indication may indicate the restriction of the initial BWP to CORESET 0 is removed or lifted, and c) the first BWP may have the allocation of up to the whole initial BWP.

In some embodiments, at least one of may apply: a) the size of the buffer comprising the data may be smaller than the threshold, b) the data may be the small data transmission, SDT, c) the data may be configured for SDT, d) the sending 501 of the first indication may be to the wireless device 130, e) the first BWP may be applicable as long as cell reselection is not performed, f) the first indication may indicate the first identifier of the first BWP and the second identifier of the CORESET, and the first BWP and the CORESET may be indicated in SI, and g) the first BWP may be the downlink BWP corresponding to the uplink BWP used for MO-SDT.

In some embodiments, the method may further comprise one or more of the following actions.

### Action 502

In this Action 502, the network node 110 may send the second indication.

The sending in this Action 502 may be to the wireless device 130.

The sending in this Action 502 may be performed, e.g., via the first link 141.

The sending in this Action 502 may be after having sent the first indication. The sending in this Action 502 may be based on the sent first indication. The second indication may indicate to switch to the first BWP.

The sending in this Action 502 of the second indication may be one of: a) over RRC signalling, b) while the wireless device 130 may remain in inactive state, c) by expiration of the timer, and d) via the MAC CE.

In some embodiments, the wireless device 130 may refrain from switching BWP. The wireless device 130, e.g., in some of these embodiments, may obtain the frequency domain resource allocation of up to the entire initial DL BWP while performing small data transmissions.

In some embodiments, at least one of the following may apply: a) the switching may be supported by the DCI format selected from DCI 0_0 and DCI 1_0, and b) the second indication may comprise the indicator the first BWP to switch to.

### Action 503

In this Action 503, network node 110 may the data to the wireless device 130 in the first BWP.

The data may be sent to the wireless device 130 in the first BWP, after the wireless device 130 may have switched to the first BWP.

FIG. 6 is a signalling diagram depicting a non-limiting example of embodiments herein using RRCReconfiguration to switch to a new BWP, that is, the first BWP, during MT-SDT procedure. As mentioned earlier, RRCReconfiguration may support defining and switching a UE to a new BWP in CONNECTED mode. In one example of the second indication according to Action 402 and Action 502 of embodiments herein, an RRCReconfiguration may be triggered by the network node 110, a gNB in FIG. 6, for the wireless device 130, a UE in this Figure, while the wireless device 130 may remain in the INACTIVE mode as shown in FIG. 6, to trigger a switch to the first BWP. The wireless device 103 may switch to the first BWP according to Action 403. Then subsequent DL data may be sent, according to Action 503, by the network node 110 to the wireless device 130. The wireless device 130 may receive the subsequent DL data in the first BWP according to Action 404. The wireless device 130 may have obtained the first indication, and the network node 110 may have sent the first indication according to any of the options described above. The remaining actions depicted in FIG. 6 may be understood to otherwise have a similar description to that provided in relation to FIG. 2.

As a summarized overview of the foregoing, embodiments herein provide methods that may enable the wireless device 130, e.g., a UE, to use a larger BWP while transmitting DL data as part of MT-SDT functionality.

Certain embodiments disclosed herein may provide one or more of the following technical advantage(s), which may be summarized as follows.

Embodiments herein may be understood to support a larger BWP for DL MT-SDT transmissions which may enable reducing the total number of transmissions within the MT-SDT procedure. Reducing the signalling overhead, in turn, may result in reduced energy consumption for the wireless device 130, e.g., the UE.

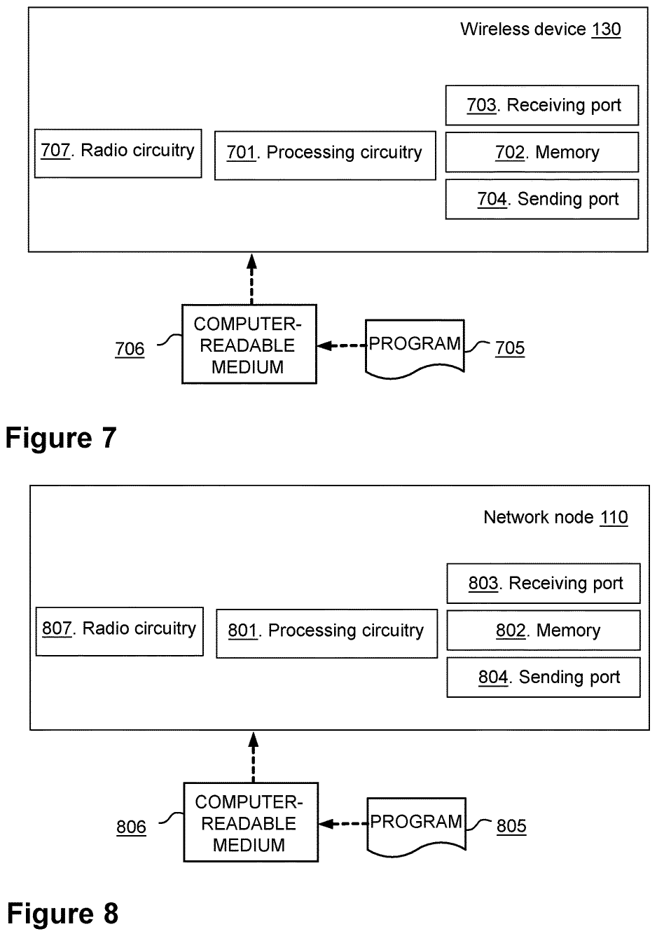

FIG. 7 depicts an example of the arrangement that the wireless device 130 may comprise to perform the method actions described above in relation to FIG. 4 and/or FIG. 6. The wireless device 130 may be understood to be for handling the BWP. The wireless device 130 is configured to operate in the wireless communications network 100.

Several embodiments are comprised herein. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the wireless device 130 and will thus not be repeated here. For example, the connected mode may be an RRC connected mode.

The wireless device 130 is configured and/or operable to perform the obtaining in Action 401, e.g. by means of a processing circuitry 701 within the wireless device, configured to obtain the first indication. The first indication is configured to indicate the first BWP, different than the second BWP. The second BWP is configured to be the subset of the initial BWP. The first BWP is configured to be for transmission, by the network node 110 configured to operate in the wireless communications network 100, of data to the wireless device 130 in inactive state.

In some embodiments, the obtaining of the first indication may be configured to be one of the following: a) at RRCRelease, b) via the dedicated configuration, c) via the information IE, configured to be comprised in the SDT configuration, d) via the cg-SDT-ConfigBWP-DL IE configured to be comprised in the SDT configuration, e) via the cg-SDT-ConfigInitialBWP-DL IE configured to be comprised in the SDT configuration, f) via the specific common BWP configuration, g) via the specific common BWP configuration that the wireless device 130 may be configured to be enabled to switch to after receiving the initial transmission of data within the random access procedure, as part of message 4, h) via the mtsdt-BWP IE, i) via the mtsdt-BWP, wherein the mtsdt-BWP may be configured to comprise only common parameters of a downlink BWP, j) via the BWP-Downlink-SDT, configured to comprise one of: j.1) common parameters and j.2) common parameters and dedicated parameters, k) via the Mtdst-BWP configured to comprise dedicated parameters, wherein the dedicated parameters may be configured to comprise at least one of: the different CORESET than the second BWP, the different search space than the second BWP and the NCD-SSB, l) via SI, m) via SIB1, n) via the ServingCellConfig IE configured to be received in SI, o) over the paging message, and p) over the MT-SDT paging message.

In some embodiments, at least one of the following may apply: a) the size of the buffer configured to comprise the data may be configured to be smaller than the threshold, b) the data may be configured to be the SDT, c) the data may be configured to be configured for SDT, d) the obtaining of the first indication may be configured to be from the network node 110, e) the first BWP may be configured to be applicable as long as cell reselection is not performed, f) the first indication may be configured to indicate the first identifier of the first BWP and the second identifier of a CORESET, and the first BWP and the CORESET may be configured to be indicated in SI, and g) the first BWP may be configured to be a downlink BWP corresponding to an uplink BWP configured to be used for MO-SDT.

The wireless device 130 may be configured and/or operable to perform the receiving in Action 404, e.g. by means of the processing circuitry 501 within the wireless device 130, configured to receive the data from the network node 110 in the first BWP.

In some embodiments, the wireless device 130 may be configured with at least one, or all, of the following three configurations

The wireless device 130 may be configured and/or operable to perform the obtaining in Action 402, e.g., by means of the processing circuitry 501, configured to obtain, after having obtained the first indication, the second indication configured to indicate to switch to the first BWP.

The wireless device 130 may be configured and/or operable to perform the switching in Action 403, e.g. by means of the processing circuitry 501, configured to switch to the first BWP, based on the second indication configured to be received.

In some of these embodiments, the data may be configured to be received from the network node 110 in the first BWP, after having switched to the first BWP.

In some embodiments, at least one of the following may apply: i) the switching may be configured to be supported by the DCI format configured to be selected from DCI 0_0 and DCI 1_0, and b) the second indication may be configured to comprise the indicator of the first BWP to switch to.

In some embodiments, the obtaining of the second indication may be configured to be one of: a) from the network node 110, b) over RRC signalling, c) while the wireless device 130 remains in inactive state, d) by expiration of the timer, e) via a MAC CE and, f) via a pre-configuration.

In some embodiments, at least one of: a) the subset of the initial BWP may be configured to be a bandwidth of CORESET 0, b) the first indication may be configured to indicate the restriction of the initial BWP to CORESET 0 is removed, and c) the first BWP may be configured to have the allocation of up to the whole initial BWP.

In some embodiments, the wireless device 130 may be configured to refrain from switching BWP, and may be configured to obtain the frequency domain resource allocation of up to the entire initial DL BWP while performing small data transmissions.

The embodiments herein in the wireless device 130 may be implemented through one or more processors, such as a processing circuitry 701 in the wireless device 130 depicted in FIG. 7, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the wireless device 130. One such carrier may be in the form of a CD ROM disc. It is however feasible with other data carriers such as a memory stick. The computer program code may furthermore be provided as pure program code on a server and downloaded to the wireless device 130.

The processing circuitry 701 may be configured to, or operable to, perform the method actions according to FIG. 4 and/or FIG. 6.

The wireless device 130 may further comprise a memory 702 comprising one or more memory units. The memory 702 is arranged to be used to store obtained information, store data, configurations, schedulings, and applications etc. to perform the methods herein when being executed in the wireless device 130.

In some embodiments, the wireless device 130 may receive information from, e.g., the network node 110 or another structure in the wireless communications network 100, through a receiving port 703. In some embodiments, the receiving port 703 may be, for example, connected to one or more antennas in wireless device 130. In other embodiments, the wireless device 130 may receive information from another structure in the wireless communications network 100 through the receiving port 703. Since the receiving port 703 may be in communication with the processing circuitry 701, the receiving port 703 may then send the received information to the processing circuitry 701. The receiving port 703 may also be configured to receive other information.

The processing circuitry 701 in the wireless device 130 may be further configured to transmit or send information to e.g., the network node 110 or another structure in the wireless communications network 100, through a sending port 704, which may be in communication with the processing circuitry 701, and the memory 702.

Those skilled in the art will also appreciate that the processing circuitry 701 described above may comprise a combination of analog and digital modules, and/or one or more processors configured with software and/or firmware, e.g., stored in memory, that, when executed by the one or more processors such as the processing circuitry 701, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the wireless device 130 may be configured to perform the actions of FIG. 4 and/or FIG. 6 with respective units that may be implemented as one or more applications running on one or more processors such as the processing circuitry 701.

Thus, the methods according to the embodiments described herein for the wireless device 130 may be respectively implemented by means of a computer program 705 product, comprising instructions, i.e., software code portions, which, when executed on at least one processing circuitry 701, cause the at least one processing circuitry 701 to carry out the actions described herein, as performed by the wireless device 130. The computer program 705 product may be stored on a computer-readable storage medium 706. The computer-readable storage medium 706, having stored there on the computer program 705, may comprise instructions which, when executed on at least one processing circuitry 701, cause the at least one processing circuitry 701 to carry out the actions described herein, as performed by the wireless device 130. In some embodiments, the computer-readable storage medium 706 may be a non-transitory computer-readable storage medium, such as a CD ROM disc, or a memory stick. In other embodiments, the computer program 705 product may be stored on a carrier containing the computer program 705 just described, wherein the carrier is one of an electronic signal, optical signal, radio signal, or the computer-readable storage medium 706, as described above.

The wireless device 130 may comprise a communication interface configured to facilitate communications between the wireless device 130 and other nodes or devices, e.g., the network node 110 or another structure in the wireless communications network 100. The interface may, for example, include a transceiver configured to transmit and receive radio signals over an air interface in accordance with a suitable standard.

In other embodiments, the wireless device 130 may also comprise a radio circuitry 707, which may comprise e.g., the receiving port 703 and the sending port 704. The radio circuitry 707 may be configured to set up and maintain at least a wireless connection with the network node 110 or another structure in the wireless communications network 100. Circuitry may be understood herein as a hardware component.

Hence, embodiments herein also relate to the wireless device 130 comprising the processing circuitry 701 and the memory 702, said memory 702 containing instructions executable by said processing circuitry 701, whereby the wireless device 130 is operative to perform the actions described herein in relation to the wireless device 130, e.g., in FIG. 4 and/or FIG. 6.

FIG. 8 depicts an example of the arrangement that the network node 110 may comprise to perform the method actions described above in relation to FIG. 5 and/or FIG. 6. The network node 110 may be understood to be for handling the BWP of the wireless device 130. The network node 110 is configured to operate in the wireless communications network 100.

Several embodiments are comprised herein. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the network node 110 and will thus not be repeated here. For example, the connected mode may be an RRC connected mode.

The network node 110 is configured and/or operable to perform the sending in Action 501, e.g. by means of a processing circuitry 801 within the network node 110, configured to send a first indication. The first indication is configured to indicate the first BWP, different than the second BWP. The second BWP is configured to be the subset of the initial BWP. The first BWP is configured to be for transmission, by the network node 110, of data to the wireless device 130 configured to operate in the wireless communications network 100, in inactive state.

In some embodiments, the sending of the first indication may be configured to be one of the following: a) at RRCRelease, b) via the dedicated configuration, c) via the information IE, configured to be comprised in the SDT configuration, d) via the cg-SDT-ConfigBWP-DL IE configured to be comprised in the SDT configuration, e) via the cg-SDT-ConfigInitialBWP-DL IE configured to be comprised in the SDT configuration, f) via the specific common BWP configuration, g) via the specific common BWP configuration that the wireless device 130 may be configured to be enabled to switch to after receiving the initial transmission of data within the random access procedure, as part of message 4, h) via the mtsdt-BWP IE, i) via the mtsdt-BWP, wherein the mtsdt-BWP may be configured to comprise only common parameters of a downlink BWP, j) via the BWP-Downlink-SDT, configured to comprise one of: j.1) common parameters and j.2) common parameters and dedicated parameters, k) via the Mtdst-BWP configured to comprise dedicated parameters, wherein the dedicated parameters may be configured to comprise at least one of: the different CORESET than the second BWP, the different search space than the second BWP and the NCD-SSB, l) via SI, m) via SIB1, n) via the ServingCellConfig IE configured to be received in SI, o) over the paging message, and p) over the MT-SDT paging message.

In some embodiments, at least one of the following may apply: a) the size of the buffer configured to comprise the data may be smaller than the threshold, b) the data may be configured to be the SDT, c) the data may be configured to be configured for SDT, d) the sending of the first indication may be configured to be to the wireless device 130, e) the first BWP may be configured to be applicable as long as cell reselection is not performed, f) the first indication may be configured to indicate the first identifier of the first BWP and the second identifier of a CORESET, and the first BWP and the CORESET may be configured to be indicated in SI, and g) the first BWP may be configured to be the downlink BWP corresponding to the uplink BWP configured to be used for MO-SDT.

The network node 110 may be configured and/or operable to perform the sending in Action 503, e.g. by means of the processing circuitry 801, configured to send the data to the wireless device 130 in the first BWP.

The network node 110 may be configured and/or operable to perform the sending in Action 502, e.g. by means of the processing circuitry 801, configured to send, after having sent the first indication, the second indication to the wireless device 130 configured to indicate to switch to the first BWP. The data may be configured to be sent to the wireless device 130 in the first BWP after the wireless device 130 may have switched to the first BWP.

In some embodiments, at least one of the following may apply: a) the switching may be configured to be supported by the DCI format configured to be selected from DCI 0_0 and DCI 1_0, and b) the second indication may be configured to comprise the indicator of the first BWP to switch to.

In some embodiments, the sending of the second indication may be configured to be one of: a) over RRC signalling, b) while the wireless device 130 remains in inactive state, c) by expiration of the timer, and d) via the MAC CE.

In some embodiments at least one of the following may apply: a) the subset of the initial BWP may be configured to be a bandwidth of CORESET 0, b) the first indication may be configured to indicate the restriction of the initial BWP to CORESET 0 is removed, and c) the first BWP may be configured to have the allocation of up to the whole initial BWP.

In some embodiments, the wireless device 130 may be configured to refrain from switching BWP and may be configured to obtain the frequency domain resource allocation of up to the entire initial DL BWP while performing small data transmissions.

The embodiments herein in the network node 110 may be implemented through one or more processors, such as a processing circuitry 801 in the network node 110 depicted in FIG. 8, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the network node 110. One such carrier may be in the form of a CD ROM disc. It is however feasible with other data carriers such as a memory stick. The computer program code may furthermore be provided as pure program code on a server and downloaded to the network node 110.

The processing circuitry 801 may be configured to, or operable to, perform the method actions according to FIG. 5 and/or FIG. 6.

The network node 110 may further comprise a memory 802 comprising one or more memory units. The memory 802 is arranged to be used to store obtained information, store data, configurations, schedulings, and applications etc. to perform the methods herein when being executed in the network node 110.

In some embodiments, the network node 110 may receive information from, e.g., the wireless device 130 and/or another structure in the wireless communications network 100, through a receiving port 803. In some embodiments, the receiving port 803 may be, for example, connected to one or more antennas in network node 110. In other embodiments, the network node 110 may receive information from another structure in the wireless communications network 100 through the receiving port 803. Since the receiving port 803 may be in communication with the processing circuitry 801, the receiving port 803 may then send the received information to the processing circuitry 801. The receiving port 803 may also be configured to receive other information.

The processing circuitry 801 in the network node 110 may be further configured to transmit or send information to e.g., the wireless device 130 and/or another structure in the wireless communications network 100, through a sending port 804, which may be in communication with the processing circuitry 801, and the memory 802.

Those skilled in the art will also appreciate that the processing circuitry 801 described above may comprise a combination of analog and digital modules, and/or one or more processors configured with software and/or firmware, e.g., stored in memory, that, when executed by the one or more processors such as the processing circuitry 801, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the network node 110 may be configured to perform the actions of FIG. 5 and/or FIG. 6 with respective units that may be implemented as one or more applications running on one or more processors such as the processing circuitry 801.

Thus, the methods according to the embodiments described herein for the network node 110 may be respectively implemented by means of a computer program 805 product, comprising instructions, i.e., software code portions, which, when executed on at least one processing circuitry 801, cause the at least one processing circuitry 801 to carry out the actions described herein, as performed by the network node 110. The computer program 805 product may be stored on a computer-readable storage medium 806. The computer-readable storage medium 806, having stored thereon the computer program 805, may comprise instructions which, when executed on at least one processing circuitry 801, cause the at least one processing circuitry 801 to carry out the actions described herein, as performed by the network node 110. In some embodiments, the computer-readable storage medium 806 may be a non-transitory computer-readable storage medium, such as a CD ROM disc, or a memory stick. In other embodiments, the computer program 805 product may be stored on a carrier containing the computer program 805 just described, wherein the carrier is one of an electronic signal, optical signal, radio signal, or the computer-readable storage medium 806, as described above.

The network node 110 may comprise a communication interface configured to facilitate communications between the network node 110 and other nodes or devices, e.g., the wireless device 130 and/or another structure in the wireless communications network 100. The interface may, for example, include a transceiver configured to transmit and receive radio signals over an air interface in accordance with a suitable standard.

In other embodiments, the network node 110 may also comprise a radio circuitry 807, which may comprise e.g., the receiving port 803 and the sending port 804. The radio circuitry 807 may be configured to set up and maintain at least a wireless connection with the wireless device 130 and/or another structure in the wireless communications network 100. Circuitry may be understood herein as a hardware component.

Hence, embodiments herein also relate to the network node 110 comprising the processing circuitry 801 and the memory 802, said memory 802 containing instructions executable by said processing circuitry 801, whereby the network node 110 is operative to perform the actions described herein in relation to the network node 110, e.g., in FIG. 5 and/or FIG. 6.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

As used herein, the expression “at least one of:” followed by a list of alternatives separated by commas, and wherein the last alternative is preceded by the “and” term, may be understood to mean that only one of the list of alternatives may apply, more than one of the list of alternatives may apply or all of the list of alternatives may apply. This expression may be understood to be equivalent to the expression “at least one of:” followed by a list of alternatives separated by commas, and wherein the last alternative is preceded by the “or” term. Msg1/2/3/4/5 may be understood to refer to Message 1/2/3/4/5 of 4-step random access procedure.

MsgA/B may be understood to refer to Message A/B of 2-step random access procedure.

### EXAMPLES RELATED TO EMBODIMENTS HEREIN

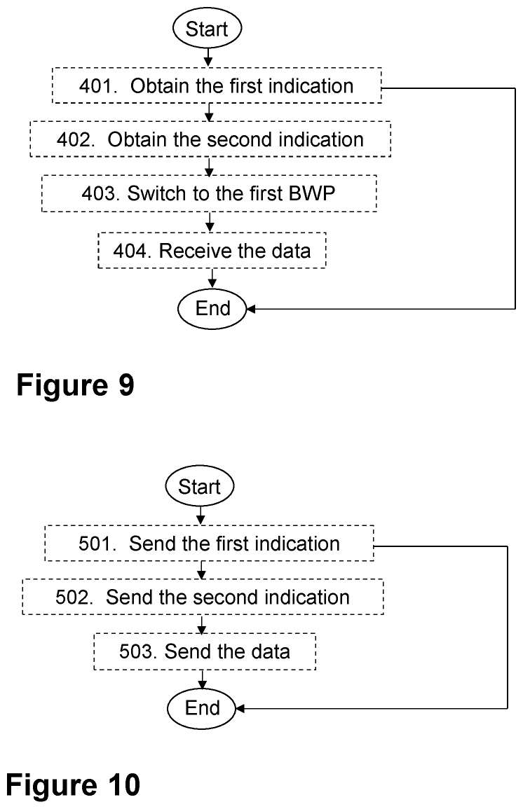

FIG. 9 depicts a method performed by the wireless device 130 in examples related to embodiments herein, according to the description of the actions provided in relation to FIG. 4.

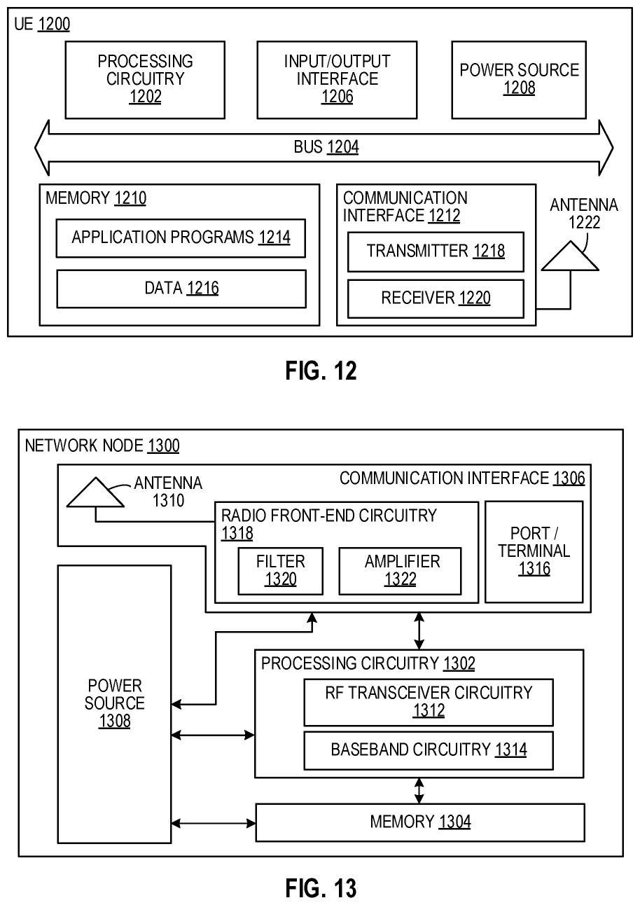

The wireless device 130 examples related to embodiments herein relate to FIG. 9, FIG. 6, FIG. 7 and FIGS. 11-16.

A method, performed by a wireless device, such as the wireless device 130 is described herein. The method may be understood to be for handling a BWP. The wireless device 130 may be operating in a wireless communications network, such as the wireless communications network 100.

In some examples related to embodiments herein, the wireless communications network 100 may support, or operate in, New Radio (NR).

The method may comprise one or more of the following actions. In particular examples, the method may comprise Action 401. In some examples related to embodiments herein, all the actions may be performed. One or more examples related to embodiments herein may be combined, where applicable. Components from one example related to embodiments herein may be tacitly assumed to be present in another example related to embodiments herein and it will be obvious to a person skilled in the art how those components may be used in the other exemplary examples related to embodiments herein. All possible combinations are not described to simplify the description. A non-limiting example of the method performed by the wireless device 130 is depicted in FIG. 9. In FIG. 9 optional actions in some examples related to embodiments herein may be represented with dashed lines. In some examples related to embodiments herein, the actions may be performed in a different order than that depicted FIG. 9.
Obtaining 401 a first indication. The wireless device 130 may be configured and/or operable to perform the obtaining in this Action 401.

Obtaining may comprise receiving, e.g., via the first link 141, from the network node 110 or another network node, or device, or retrieving, e.g., from a memory.

The first indication may indicate a first BWP. The first BWP may be different than a second BWP. The second BWP may be a subset of an initial BWP, e.g., up to 48 Physical Resource Blocks (PRBs) within CORESET 0.

The first BWP may be for transmission. In some examples, the indication may further indicate the first BWP is for transmission. The transmission may be, e.g., by a network node such as the network node 110, of data to the wireless device 130. The transmission may be, e.g., in inactive state.

A size of a buffer comprising the data may be smaller than a threshold. That is, the data may be small data, e.g., an SDT. In some examples, the data may be configured for SDT, e.g., MT-SDT. That is, the transmission may be an SDT.

In some examples related to embodiments herein, the obtaining in this Action 401 of the first indication may be one of:
at RRCRelease,
via a dedicated configuration,
via an information element (IE) comprised in an SDT configuration,
via a cg-SDT-ConfigBWP-DL IE comprised in the SDT configuration,
via a cg-SDT-ConfigInitialBWP-DL IE comprised in the SDT configuration,
via a specific common BWP configuration,
via the specific common BWP configuration that the wireless device 130 is enabled to switch to after receiving an initial transmission of data within a random access procedure, as part of message 4,
via an mtsdt-BWP-r18 IE,
via the mtsdt-BWP-r18, wherein the mtsdt-BWP-r18 comprises, e.g., only, common parameters of a downlink BWP,
via the BWP-Downlink-SDT-r18, comprising one of: a) common parameters and b) common parameters and dedicated parameters,
via the Mtdst-BWP-r18 comprising dedicated parameters, wherein the dedicated parameters comprise at least one of: a different CORESET than the second BWP, a different search space than the second BWP and a Non Cell Defining Synchronization Signal Block, NCD-SSB,
via System Information (SI),
via System Information Block 1 (SIB1),
via a ServingCellConfig IE received in SI,
over a paging message, and
over a Mobile Terminated Small Data Transmission (MT-SDT) paging message.

In some examples related to embodiments herein, at least one of the following may apply:
the subset of the initial BWP may be a bandwidth of CORESET 0,
the first indication may indicate a restriction of the initial BWP to CORESET 0 is removed or lifted, and
the first BWP may have an allocation of up to the whole initial BWP.

In some examples related to embodiments herein, at least one of may apply:
the obtaining 401 of the first indication may be from the network node 110,
the first BWP may be applicable as long as cell reselection is not performed,
the first indication may indicate a first identifier of the first BWP and a second identifier of a CORESET, and the first BWP and the CORESET may be indicated in SI, and
the first BWP may be a downlink BWP corresponding to an uplink BWP used for Mobile Originated Small Data Transmission (MO-SDT).

In some examples related to embodiments herein, the method may further comprise one or more of the following actions:
Receiving 404 the data. The wireless device 130 may be configured and/or operable to perform the receiving in this Action 404.

The receiving in this Action 404 may be from the network node 110.

The receiving in this Action 404 may be performed, e.g., via the first link 141.

The receiving in this Action 404 may be in the first BWP. The receiving in this Action 404 may be based on the obtained first indication.
Obtaining 402 a second indication. The wireless device 130 may be configured and/or operable to perform the obtaining in this Action 402.

The obtaining in this Action 402 may be after having obtained the first indication.

Obtaining may comprise receiving, e.g., via the first link 141, from the network node 110 or another network node, or device, or retrieving, e.g., from a memory.

The second indication may indicate to switch to the first BWP.

The obtaining in this Action 402 may be one of:
from the network node 110,
over Radio Resource Control (RRC) signalling,
while the wireless device 130 remains in inactive state,
by expiration of a timer,
via a Medium Access Control (MAC) Control Element (CE), and
via a pre-configuration.

In some examples related to embodiments herein, the wireless device 130 may refrain from switching BWP. The wireless device 130, e.g., in some of these examples related to embodiments herein may obtains a frequency domain resource allocation of up to the entire initial DL BWP while performing small data transmissions.
Switching 403 to the first BWP. The wireless device 130 may be configured and/or operable to perform the switching in this Action 403.

The switching in this Action 403 may be based on the received second indication.

The data may be received from the network node 110 in the first BWP, after having switched to the first BWP.

In some examples related to embodiments herein, at least one of the following may apply:
the switching 403 may be supported by a DCI format selected from DCI 0_0 and DCI 1_0, and
the second indication may comprise an indicator the first BWP to switch to.

In FIG. 9, optional units are indicated with dashed boxes.

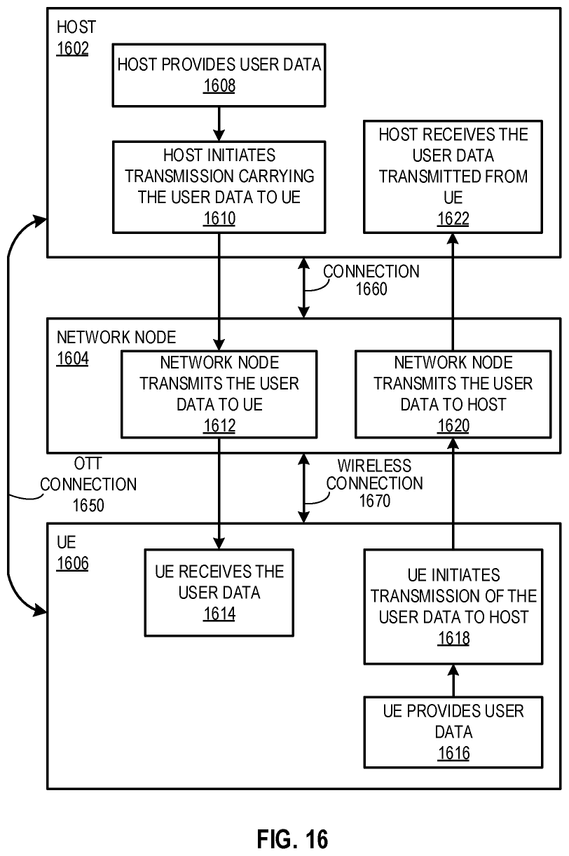

The wireless device 130 may comprise an arrangement as shown in FIG. 7 or in FIG. 16.

FIG. 10 depicts a method performed by the network node 110 in examples related to embodiments herein, according to the description of the actions provided in relation to FIG. 5.

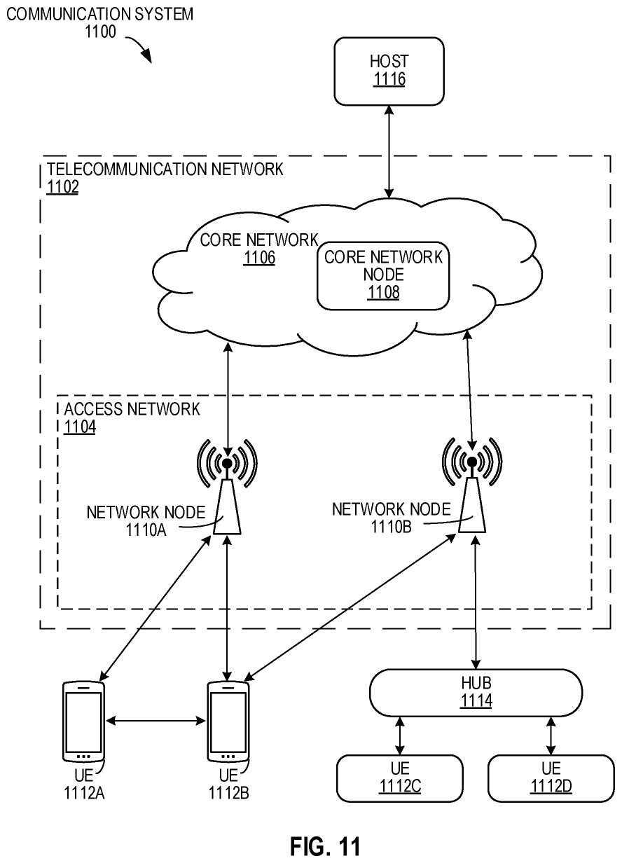

The network node 110 embodiments relate to FIG. 10, FIG. 8, and FIGS. 11-16.

A method, performed by a network node, such as the network node 110 is described herein. The method may be understood to be for handling the BWP. The network node 110 may be operating in a wireless communications network, such as the wireless communications network 100.

In some embodiments, the wireless communications network 100 may support New Radio (NR).

The method may comprise one or more of the following actions. In a particular non-limiting example, Action 501 may be performed. In some embodiments, all the actions may be performed. One or more embodiments may be combined, where applicable. Components from one example related to embodiments herein may be tacitly assumed to be present in another example related to embodiments herein and it will be obvious to a person skilled in the art how those components may be used in the other exemplary embodiments. All possible combinations are not described to simplify the description. A non-limiting example of the method performed by the network node 110 is depicted in FIG. 10. In FIG. 10, optional actions in some embodiments may be represented with dashed lines. In some embodiments, the actions may be performed in a different order than that depicted FIG. 10.

The detailed description of some of the following corresponds to the same references provided above, in relation to the actions described for the wireless device 130 and will thus not be repeated here to simplify the description. For example, the data may be SDT.
Sending 501 the first indication. The network node 110 may be configured and/or operable to perform the sending in this Action 501.

The sending in this Action 501 may be performed, e.g., via the first link 141.

The first indication may indicate the first BWP. The first BWP may be different than the second BWP. The second BWP may be the subset of the initial BWP, e.g., up to 48 Physical Resource Blocks (PRBs) within CORESET 0.

The first BWP may be for transmission. In some examples, the indication may further indicate the first BWP is for transmission. The transmission may be, e.g., by a network node such as the network node 110, of data to the wireless device 130 operating in the wireless communications network 100. The transmission may be, e.g., in inactive state.

The size of the buffer comprising the data may be smaller than the threshold. That is, the data may be small data, e.g., an SDT. In some examples, the data may be configured for SDT, e.g., MT-SDT. That is, the transmission may be an SDT.

In some embodiments, the obtaining in this Action 401 of the first indication may be one of:
at RRCRelease,
via the dedicated configuration,
via the IE comprised in the SDT configuration,
via the cg-SDT-ConfigBWP-DL IE comprised in the SDT configuration,
via the cg-SDT-ConfigInitialBWP-DL IE comprised in the SDT configuration,
via the specific common BWP configuration,
via the specific common BWP configuration that the wireless device 130 is enabled to switch to after receiving the initial transmission of data within the random access procedure, as part of message 4,
via the mtsdt-BWP-r18 IE,
via the mtsdt-BWP-r18, wherein the mtsdt-BWP-r18 comprises, e.g., only, common parameters of the downlink BWP,
via the BWP-Downlink-SDT-r18, comprising one of: a) common parameters and b) common parameters and dedicated parameters,
via the Mtdst-BWP-r18 comprising dedicated parameters, wherein the dedicated parameters comprise at least one of: the different CORESET than the second BWP, the different search space than the second BWP and the NCD-SSB,
via SI,
via SIB1,
via the ServingCellConfig IE received in SI,
over the paging message, and
over the MT-SDT paging message.

In some embodiments, at least one of the following may apply:
the subset of the initial BWP may be a bandwidth of CORESET 0,
the first indication may indicate a restriction of the initial BWP to CORESET 0 is removed or lifted, and
the first BWP may have an allocation of up to the whole initial BWP.

In some embodiments, at least one of may apply:
the obtaining 401 of the first indication may be from the network node 110,
the first BWP may be applicable as long as cell reselection is not performed,
the first indication may indicate the first identifier of the first BWP and the second identifier of the CORESET, and the first BWP and the CORESET may be indicated in SI, and
the first BWP may be the downlink BWP corresponding to the uplink BWP used for MO-SDT.

In some embodiments, the method may further comprise one or more of the following actions:
Sending 502 the second indication. The network node 110 may be configured and/or operable to perform the sending in this Action 502.

The sending in this Action 502 may be to the wireless device 130.

The sending in this Action 502 may be performed, e.g., via the first link 141.

The sending in this Action 502 may be after having sent the first indication. The sending in this Action 502 may be based on the sent first indication.

The second indication may indicate to switch to the first BWP.

The data may be sent to the wireless device 130 in the first BWP, after the wireless device 130 has switched to the first BWP.

The sending in this Action 502 may be one of:
over RRC signalling,
while the wireless device 130 remains in inactive state,
by expiration of the timer, and
via the MAC CE.

In some embodiments, the wireless device 130 may refrain from switching BWP. The wireless device 130, e.g., in some of these embodiments, may obtain the frequency domain resource allocation of up to the entire initial DL BWP while performing small data transmissions.

In some embodiments, at least one of the following may apply:
the switching may be supported by the DCI format selected from DCI 0_0 and DCI 1_0, and
the second indication may comprise the indicator the first BWP to switch to.

In FIG. 5, optional units are indicated with dashed boxes.

The network node 110 may comprise an arrangement as shown in FIG. 8 or in FIG. 16.

Selected examples related to examples herein may be as follows:

EXAMPLE 1. A method performed by a wireless device (130), the method being for handling a bandwidth part, BWP, the wireless device (130) operating in a wireless communications network (100), and the method comprising:
obtaining (401) a first indication, the first indication indicating a first BWP, different than a second BWP, the second BWP being a subset of an initial BWP, the first BWP being for transmission (e.g., the indication further indicating the first BWP is for transmission), e.g., by a network node (110), of data to the wireless device (130), e.g., in inactive state, e.g., wherein a size of a buffer comprising the data is smaller than a threshold/wherein the data is configured for SDT.

EXAMPLE 2. The method according to example 1, wherein the obtaining (401) of the first indication is one of:
at RRCRelease,
via a dedicated configuration,
via an information element, IE, comprised in a small data transmission, SDT, configuration,
via a cg-SDT-ConfigBWP-DL IE comprised in the SDT configuration,
via a cg-SDT-ConfigInitialBWP-DL IE comprised in the SDT configuration,
via a specific common BWP configuration,
via the specific common BWP configuration that the wireless device (130) is enabled to switch to after receiving an initial transmission of data within a random access procedure, as part of message 4,
via an mtsdt-BWP-r18 IE,
via the mtsdt-BWP-r18, wherein the mtsdt-BWP-r18 comprises, e.g., only, common parameters of a downlink BWP,
via the BWP-Downlink-SDT-r18, comprising one of: a) common parameters and b) common parameters and dedicated parameters,
via the Mtdst-BWP-r18 comprising dedicated parameters, wherein the dedicated parameters comprise at least one of: a different CORESET than the second BWP, a different search space than the second BWP and a Non Cell Defining Synchronization Signal Block, NCD-SSB,
via System Information, SI,
via System Information Block 1, SIB1,
via a ServingCellConfig IE received in SI,
over a paging message, and
over a Mobile Terminated Small Data Transmission, MT-SDT paging message.

EXAMPLE 3. The method according to any of examples 1-2, wherein at least one of:
the obtaining (401) of the first indication is from the network node (110),
the first BWP is applicable as long as cell reselection is not performed,
the first indication indicates a first identifier of the first BWP and a second identifier of a CORESET, and wherein the first BWP and the CORESET are indicated in SI, and
the first BWP is a downlink BWP corresponding to an uplink BWP used for Mobile Originated Small Data Transmission, MO-SDT.

EXAMPLE 4. The method according to any of examples 1-3, further comprising:
receiving (404) the data from the network node (110) in the first BWP.

EXAMPLE 6. The method according to any of examples 1-4, further comprising:
obtaining (402), after having obtained the first indication, a second indication indicating to switch to the first BWP,
switching (403) to the first BWP, based on the received second indication, and
wherein the data is received from the network node (110) in the first BWP, after having switched to the first BWP.

EXAMPLE 6. The method according to example 5, wherein at least one of:
the switching (403) is supported by a Downlink Control Information, DCI, format selected from DCI 0_0 and DCI 1_0, and
the second indication comprises an indicator the first BWP to switch to.

EXAMPLE 7. The method according to any of examples 5-6, wherein the obtaining (402) of the second indication is one of:
from the network node (110),
over Radio Resource Control, RRC, signalling,
while the wireless device (130) remains in inactive state,
by expiration of a timer,
via a Medium Access Control, MAC, Control Element, CE, and
via a pre-configuration.

EXAMPLE 8. The method according to any of examples 1-4, wherein at least one of:
the subset of the initial BWP, is a bandwidth of CORESET 0,
the first indication indicates a restriction of the initial BWP to CORESET 0 is removed, and
the first BWP has an allocation of up to the whole initial BWP.

EXAMPLE 9. The method according to any of examples 1-4, wherein the wireless device (130) refrains from switching BWP, and obtains a frequency domain resource allocation of up to the entire initial DL BWP while performing small data transmissions.

EXAMPLE 10. A method performed by a network node (110), the method being for handling a bandwidth part, BWP, the network node (110) operating in a wireless communications network (100), and the method comprising:
sending (501) a first indication, the first indication indicating a first BWP, different than a second BWP, the second BWP being a subset of an initial BWP, the first BWP being for transmission (e.g., the indication further indicating the first BWP is for transmission), e.g., by the network node (110), of data to a wireless device (130) operating in the wireless communications network (100), e.g., in inactive state, e.g., wherein a size of a buffer comprising the data is smaller than a threshold/wherein the data is configured for SDT.

EXAMPLE 11. The method according to example 10, wherein the sending (501) of the first indication is one of:
at RRCRelease,
via a dedicated configuration,
via an information element, IE, comprised in a small data transmission, SDT, configuration,
via a cg-SDT-ConfigBWP-DL IE comprised in the SDT configuration,
via a cg-SDT-ConfigInitialBWP-DL IE comprised in the SDT configuration,
via a specific common BWP configuration,
via the specific common BWP configuration that the wireless device (130) is enabled to switch to after receiving an initial transmission of data within a random access procedure, as part of message 4,
via an mtsdt-BWP-r18 IE,
via the mtsdt-BWP-r18, wherein the mtsdt-BWP-r18 comprises, e.g., only, common parameters of a downlink BWP,
via the BWP-Downlink-SDT-r18, comprising one of: a) common parameters and b) common parameters and dedicated parameters,
via the Mtdst-BWP-r18 comprising dedicated parameters, wherein the dedicated parameters comprise at least one of: a different CORESET than the second BWP, a different search space than the second BWP and a Non Cell Defining Synchronization Signal Block, NCD-SSB,
via System Information, SI,
via System Information Block 1, SIB1,
via a ServingCellConfig IE received in SI,
over a paging message, and
over a Mobile Terminated Small Data Transmission, MT-SDT paging message.

EXAMPLE 12. The method according to any of examples 10-11, wherein at least one of:
the sending (501) of the first indication is to the wireless device (130),
the first BWP is applicable as long as cell reselection is not performed,
the first indication indicates a first identifier of the first BWP and a second identifier of a CORESET, and wherein the first BWP and the CORESET are indicated in SI, and
the first BWP is a downlink BWP corresponding to an uplink BWP used for Mobile Originated Small Data Transmission, MO-SDT.

EXAMPLE 13. The method according to any of examples 10-12, further comprising:
sending (503) the data to the wireless device (130) in the first BWP.

EXAMPLE 14. The method according to any of examples 10-13, further comprising:
sending (502), after having sent the first indication, a second indication to the wireless device (130) indicating to switch to the first BWP, and wherein the data is sent to the wireless device (130) in the first BWP, e.g., after the wireless device (130) has switched to the first BWP.

EXAMPLE 15. The method according to example 14, wherein at least one of:
the switching is supported by a Downlink Control Information, DCI, format selected from DCI 0_0 and DCI 1_0, and
the second indication comprises an indicator the first BWP to switch to.

EXAMPLE 16. The method according to any of examples 14-15, wherein the sending (502) of the second indication is one of:
over Radio Resource Control, RRC, signalling,
while the wireless device (130) remains in inactive state,
by expiration of a timer, and
via a Medium Access Control, MAC, Control Element, CE.

EXAMPLE 17. The method according to any of examples 10-13, wherein at least one of:
the subset of the initial BWP, is a bandwidth of CORESET 0,
the first indication indicates a restriction of the initial BWP to CORESET 0 is removed, and
the first BWP has an allocation of up to the whole initial BWP.

EXAMPLE 18. The method according to any of examples 10-13, wherein the wireless device (130) refrains from switching BWP and obtains a frequency domain resource allocation of up to the entire initial DL BWP while performing small data transmissions.

EXAMPLE 19. A wireless device (130), for handling a bandwidth part, BWP, the wireless device (130) being configured to operate in a wireless communications network (100), and the wireless device (130) being further configured to perform a method according to any of examples 1-9.

EXAMPLE 20. A network node (110), for handling a bandwidth part, BWP, the network node (110) being configured to operate in a wireless communications network (100), the network node (110) being configured to perform the method according to any of examples 10-18.

### Further Extensions And Variations

FIG. 11 shows an example of a communication system 1100 in accordance with some embodiments.

In the example, the communication system 1100, such as the wireless communications network 100, includes a telecommunication network 1102 that includes an access network 1104, such as a radio access network (RAN), and a core network 1106, which includes one or more core network nodes 1108. The access network 1104 includes one or more access network nodes, such as the network node 110. For example, network nodes 1110a and 1110b, one or more of which may be generally referred to as network nodes 1110, or any other similar 3^{rd} Generation Partnership Project (3GPP) access node or non-3GPP access point. The communications system 1100 comprises a plurality of wireless devices, such as the wireless device 130. In FIG. 11, the plurality of wireless devices comprises UEs 1112a, 1112b, 1112c, and 1112d, one or more of which may be generally referred to as UEs 1112. The network nodes 1110 facilitate direct or indirect connection of user equipment (UE), such as by connecting UEs 1112a, 1112b, 1112c, and 1112d to the core network 1106 over one or more wireless connections. Any of the UEs 1112a, 1112b, 1112c, and 1112d are examples of the wireless device 130.

In relation to FIGS. 11, 14, and 16, which are described next, it may be understood that any UE is an example of the wireless device 130, and that any description provided for the UE 1112 or for the UE 1606 equally applies to the wireless device 130. It may be also understood that any network node is an example of the network node 110, and that any description provided for any network node 1110 or for the network node 1604 equally applies to the network node 110. It may further be understood that the communication system 1100 is an example of the wireless communication network 100, and that any description provided for the communication system 1100 equally applies to the wireless communication network 100.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1100 may include any number of wired or wireless networks, network nodes, UEs, and/or any other components or systems that may facilitate or participate in the communication of data and/or signals whether via wired or wireless connections. The communication system 1100 may include and/or interface with any type of communication, telecommunication, data, cellular, radio network, and/or other similar type of system.

The wireless device 130, exemplified in FIG. 11 as the UEs 1112, may be any of a wide variety of communication devices, including wireless devices arranged, configured, and/or operable to communicate wirelessly with the network node 110, exemplified in FIG. 11 as network nodes 1110, and other communication devices. Similarly, the network nodes 1110 are arranged, capable, configured, and/or operable to communicate directly or indirectly with the UEs 1112 and/or with other network nodes or equipment in the telecommunication network 1102 to enable and/or provide network access, such as wireless network access, and/or to perform other functions, such as administration in the telecommunication network 1102.

In the depicted example, the core network 1106 connects the network nodes 1110 to one or more hosts, such as host 1116. These connections may be direct or indirect via one or more intermediary networks or devices. In other examples, network nodes may be directly coupled to hosts. The core network 1106 includes one more core network nodes, e.g., core network node 1108, that are structured with hardware and software components. Features of these components may be substantially similar to those described with respect to the UEs, network nodes, and/or hosts, such that the descriptions thereof are generally applicable to the corresponding components of the core network node 1108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1116 may be under the ownership or control of a service provider other than an operator or provider of the access network 1104 and/or the telecommunication network 1102 and may be operated by the service provider or on behalf of the service provider. The host 1116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1100 of FIG. 11 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1102 is a cellular network that implements 3GPP standardized features. Accordingly, the telecommunications network 1102 may support network slicing to provide different logical networks to different devices that are connected to the telecommunication network 1102. For example, the telecommunications network 1102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1112 are configured to transmit and/or receive information without direct human interaction. For instance, a UE may be designed to transmit information to the access network 1104 on a predetermined schedule, when triggered by an internal or external event, or in response to requests from the access network 1104. Additionally, a UE may be configured for operating in single- or multi-RAT or multi-standard mode. For example, a UE may operate with any one or combination of Wi-Fi, New Radio (NR) and LTE, i.e., being configured for multi-radio dual connectivity (MR-DC), such as E-UTRAN (Evolved-UMTS Terrestrial Radio Access Network) New Radio-Dual Connectivity (EN-DC).

In the example, the hub 1114 communicates with the access network 1104 to facilitate indirect communication between one or more UEs, e.g., UE 1112c and/or 1112d, and network nodes, e.g., network node 1110b. In some examples, the hub 1114 may be a controller, router, content source and analytics, or any of the other communication devices described herein regarding UEs. For example, the hub 1114 may be a broadband router enabling access to the core network 1106 for the UEs. As another example, the hub 1114 may be a controller that sends commands or instructions to one or more actuators in the UEs. Commands or instructions may be received from the UEs, network nodes 1110, or by executable code, script, process, or other instructions in the hub 1114. As another example, the hub 1114 may be a data collector that acts as temporary storage for UE data and, in some embodiments, may perform analysis or other processing of the data. As another example, the hub 1114 may be a content source. For example, for a UE that is a VR headset, display, loudspeaker or other media delivery device, the hub 1114 may retrieve VR assets, video, audio, or other media or data related to sensory information via a network node, which the hub 1114 then provides to the UE either directly, after performing local processing, and/or after adding additional local content. In still another example, the hub 1114 acts as a proxy server or orchestrator for the UEs, in particular in if one or more of the UEs are low energy IoT devices.

The hub 1114 may have a constant/persistent or intermittent connection to the network node 1110b. The hub 1114 may also allow for a different communication scheme and/or schedule between the hub 1114 and UEs (e.g., UE 1112c and/or 1112d), and between the hub 1114 and the core network 1106. In other examples, the hub 1114 is connected to the core network 1106 and/or one or more UEs via a wired connection. Moreover, the hub 1114 may be configured to connect to an M2M service provider over the access network 1104 and/or to another UE over a direct connection. In some scenarios, UEs may establish a wireless connection with the network nodes 1110 while still connected via the hub 1114 via a wired or wireless connection. In some embodiments, the hub 1114 may be a dedicated hub—that is, a hub whose primary function is to route communications to/from the UEs from/to the network node 1110b. In other embodiments, the hub 1114 may be a non-dedicated hub—that is, a device which is capable of operating to route communications between the UEs and network node 1110b, but which is additionally capable of operating as a communication start and/or end point for certain data channels.

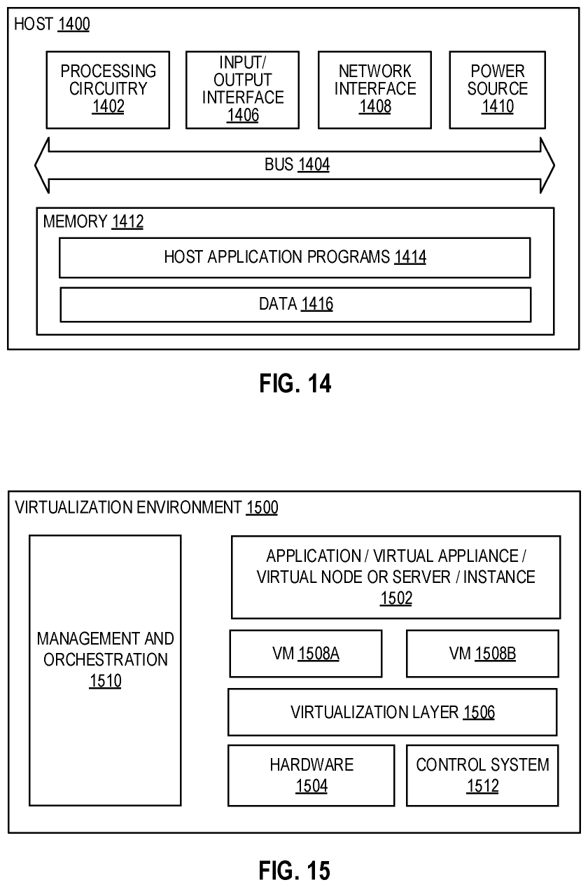

FIG. 14 is a block diagram of a host 1400, which may be an embodiment of the host 1116 of FIG. 11, in accordance with various aspects described herein. As used herein, the host 1400 may be or comprise various combinations hardware and/or software, including a standalone server, a blade server, a cloud-implemented server, a distributed server, a virtual machine, container, or processing resources in a server farm. The host 1400 may provide one or more services to one or more UEs.

The host 1400 includes processing circuitry 1402 that is operatively coupled via a bus 1404 to an input/output interface 1406, a network interface 1408, a power source 1410, and a memory 1412. Other components may be included in other embodiments. Features of these components may be substantially similar to those described with respect to the devices of previous figures, such that the descriptions thereof are generally applicable to the corresponding components of host 1400.

The memory 1412 may include one or more computer programs including one or more host application programs 1414 and data 1416, which may include user data, e.g., data generated by a UE for the host 1400 or data generated by the host 1400 for a UE. Embodiments of the host 1400 may utilize only a subset or all of the components shown. The host application programs 1414 may be implemented in a container-based architecture and may provide support for video codecs, (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1414 may also provide for user authentication and licensing checks and may periodically report health, routes, and content availability to a central node, such as a device in or on the edge of a core network. Accordingly, the host 1400 may select and/or indicate a different host for over-the-top services for a UE. The host application programs 1414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 16 shows a communication diagram of a host 1602 communicating via a network node 1604 with a UE 1606 over a partially wireless connection in accordance with some embodiments. Example implementations, in accordance with various embodiments, of the UE, such as a UE 1112a of Figure QQ, network node, such as network node 1110a of FIG. 11, and host, such as host 1116 of FIG. 11 and/or host 1400 of FIG. 14, discussed in the preceding paragraphs will now be described with reference to FIG. 16.

Like host 1400, embodiments of host 1602 include hardware, such as a communication interface, processing circuitry, and memory. The host 1602 also includes software, which is stored in or accessible by the host 1602 and executable by the processing circuitry. The software includes a host application that may be operable to provide a service to a remote user, such as the UE 1606 connecting via an over-the-top (OTT) connection 1650 extending between the UE 1606 and host 1602. In providing the service to the remote user, a host application may provide user data which is transmitted using the OTT connection 1650.

The network node 1604 includes hardware enabling it to communicate with the host 1602 and UE 1606. The connection 1660 may be direct or pass through a core network (like core network 1106 of FIG. 11) and/or one or more other intermediate networks, such as one or more public, private, or hosted networks. For example, an intermediate network may be a backbone network or the Internet.

The UE 1606 includes hardware and software, which is stored in or accessible by UE 1606 and executable by the UE's processing circuitry. The software includes a client application, such as a web browser or operator-specific “app” that may be operable to provide a service to a human or non-human user via UE 1606 with the support of the host 1602. In the host 1602, an executing host application may communicate with the executing client application via the OTT connection 1650 terminating at the UE 1606 and host 1602. In providing the service to the user, the UE's client application may receive request data from the host's host application and provide user data in response to the request data. The OTT connection 1650 may transfer both the request data and the user data. The UE's client application may interact with the user to generate the user data that it provides to the host application through the OTT connection 1650.

The OTT connection 1650 may extend via a connection 1660 between the host 1602 and the network node 1604 and via a wireless connection 1670 between the network node 1604 and the UE 1606 to provide the connection between the host 1602 and the UE 1606. The connection 1660 and wireless connection 1670, over which the OTT connection 1650 may be provided, have been drawn abstractly to illustrate the communication between the host 1602 and the UE 1606 via the network node 1604, without explicit reference to any intermediary devices and the precise routing of messages via these devices.

As an example of transmitting data via the OTT connection 1650, in step 1608, the host 1602 provides user data, which may be performed by executing a host application. In some embodiments, the user data is associated with a particular human user interacting with the UE 1606. In other embodiments, the user data is associated with a UE 1606 that shares data with the host 1602 without explicit human interaction. In step 1610, the host 1602 initiates a transmission carrying the user data towards the UE 1606. The host 1602 may initiate the transmission responsive to a request transmitted by the UE 1606. The request may be caused by human interaction with the UE 1606 or by operation of the client application executing on the UE 1606. The transmission may pass via the network node 1604, in accordance with the teachings of the embodiments described throughout this disclosure. Accordingly, in step 1612, the network node 1604 transmits to the UE 1606 the user data that was carried in the transmission that the host 1602 initiated, in accordance with the teachings of the embodiments described throughout this disclosure. In step 1614, the UE 1606 receives the user data carried in the transmission, which may be performed by a client application executed on the UE 1606 associated with the host application executed by the host 1602.

In some examples, the UE 1606 executes a client application which provides user data to the host 1602. The user data may be provided in reaction or response to the data received from the host 1602. Accordingly, in step 1616, the UE 1606 may provide user data, which may be performed by executing the client application. In providing the user data, the client application may further consider user input received from the user via an input/output interface of the UE 1606. Regardless of the specific manner in which the user data was provided, the UE 1606 initiates, in step 1618, transmission of the user data towards the host 1602 via the network node 1604. In step 1620, in accordance with the teachings of the embodiments described throughout this disclosure, the network node 1604 receives user data from the UE 1606 and initiates transmission of the received user data towards the host 1602. In step 1622, the host 1602 receives the user data carried in the transmission initiated by the UE 1606.

One or more of the various embodiments improve the performance of OTT services provided to the UE 1606 using the OTT connection 1650, in which the wireless connection 1670 forms the last segment. More precisely, the teachings of these embodiments may improve the data rate, latency, power consumption and thereby provide benefits such as reduced user waiting time, relaxed restriction on file size, improved content resolution, better responsiveness, and extended battery lifetime.

In an example scenario, factory status information may be collected and analyzed by the host 1602. As another example, the host 1602 may process audio and video data which may have been retrieved from a UE for use in creating maps. As another example, the host 1602 may collect and analyze real-time data to assist in controlling vehicle congestion, e.g., controlling traffic lights. As another example, the host 1602 may store surveillance video uploaded by a UE. As another example, the host 1602 may store or control access to media content such as video, audio, VR or AR which it can broadcast, multicast or unicast to UEs. As other examples, the host 1602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1650 between the host 1602 and UE 1606, in response to variations in the measurement results. The measurement procedure and/or the network functionality for reconfiguring the OTT connection may be implemented in software and hardware of the host 1602 and/or UE 1606. In some embodiments, sensors, not shown, may be deployed in or in association with other devices through which the OTT connection 1650 passes; the sensors may participate in the measurement procedure by supplying values of the monitored quantities exemplified above, or supplying values of other physical quantities from which software may compute or estimate the monitored quantities. The reconfiguring of the OTT connection 1650 may include message format, retransmission settings, preferred routing etc.; the reconfiguring need not directly alter the operation of the network node 1604. Such procedures and functionalities may be known and practiced in the art. In certain embodiments, measurements may involve proprietary UE signaling that facilitates measurements of throughput, propagation times, latency and the like, by the host 1602. The measurements may be implemented in that software causes messages to be transmitted, in particular empty or ‘dummy’ messages, using the OTT connection 1650 while monitoring propagation times, errors, etc.

The wireless device 130 embodiments relate to FIG. 4, FIG. 6, FIG. 7 and FIGS. 11-16.

The wireless device 130 may comprise an arrangement as shown in FIG. 7 or in FIG. 16.

The network node 110 embodiments relate to FIG. 5, FIG. 8, and FIGS. 11-16.

The network node 110 may comprise an arrangement as shown in FIG. 8 or in FIG. 16.

### Further Numbered Embodiments

1. A host configured to operate in a communication system to provide an over-the-top (OTT) service, the host comprising:
processing circuitry configured to provide user data; and
a network interface configured to initiate transmission of the user data to a network node in a cellular network for transmission to a user equipment (UE), the network node having a communication interface and processing circuitry, the processing circuitry of the network node configured to perform one or more of the actions described herein as performed by the network node 110.

2. The host of the previous embodiment, wherein:
the processing circuitry of the host is configured to execute a host application that provides the user data; and
the UE comprises processing circuitry configured to execute a client application associated with the host application to receive the transmission of user data from the host.

3. A method implemented in a host configured to operate in a communication system that further includes a network node and a user equipment (UE), the method comprising:
providing user data for the UE; and
initiating a transmission carrying the user data to the UE via a cellular network comprising the network node, wherein the network node performs one or more of the actions described herein as performed by the network node 110.

4. The method of the previous embodiment, further comprising, at the network node, transmitting the user data provided by the host for the UE.

5. The method of any of the previous 2 embodiments, wherein the user data is provided at the host by executing a host application that interacts with a client application executing on the UE, the client application being associated with the host application.

6. A communication system configured to provide an over-the-top service, the communication system comprising:
a host comprising:
processing circuitry configured to provide user data for a user equipment (UE), the user data being associated with the over-the-top service; and
a network interface configured to initiate transmission of the user data toward a cellular network node for transmission to the UE, the network node having a communication interface and processing circuitry, the processing circuitry of the network node configured to perform one or more of the actions described herein as performed by the network node 110.

7. The communication system of the previous embodiment, further comprising:
the network node; and/or
the user equipment.

8. The communication system of the previous 2 embodiments, wherein:
the processing circuitry of the host is configured to execute a host application, thereby providing the user data; and
the host application is configured to interact with a client application executing on the UE, the client application being associated with the host application.

9. A host configured to operate in a communication system to provide an over-the-top (OTT) service, the host comprising:
processing circuitry configured to initiate receipt of user data; and
a network interface configured to receive the user data from a network node in a cellular network, the network node having a communication interface and processing circuitry, the processing circuitry of the network node configured to perform one or more of the actions described herein as performed by the network node 110.

10. The host of the previous 2 embodiments, wherein:
the processing circuitry of the host is configured to execute a host application, thereby providing the user data; and
the host application is configured to interact with a client application executing on the UE, the client application being associated with the host application.

11. The host of the any of the previous 2 embodiments, wherein the initiating receipt of the user data comprises requesting the user data.

12. A method implemented by a host configured to operate in a communication system that further includes a network node and a user equipment (UE), the method comprising:
at the host, initiating receipt of user data from the UE, the user data originating from a transmission which the network node has received from the UE, wherein the network node performs one or more of the actions described herein as performed by the network node 110.

13. The method of the previous embodiment, further comprising at the network node, transmitting the received user data to the host.

14. A host configured to operate in a communication system to provide an over-the-top (OTT) service, the host comprising:
processing circuitry configured to provide user data; and
a network interface configured to initiate transmission of the user data to a cellular network for transmission to a user equipment (UE), wherein the UE comprises a communication interface and processing circuitry, the communication interface and processing circuitry of the UE being configured to perform one or more of the actions described herein as performed by the wireless device 130.

15. The host of the previous embodiment, wherein the cellular network further includes a network node configured to communicate with the UE to transmit the user data to the UE from the host.

16. The host of the previous 2 embodiments, wherein:
the processing circuitry of the host is configured to execute a host application, thereby providing the user data; and
the host application is configured to interact with a client application executing on the UE, the client application being associated with the host application.

17. A method implemented by a host operating in a communication system that further includes a network node and a user equipment (UE), the method comprising:
providing user data for the UE; and
initiating a transmission carrying the user data to the UE via a cellular network comprising the network node, wherein the UE performs one or more of the actions described herein as performed by the wireless device 130.

18. The method of the previous embodiment, further comprising:
at the host, executing a host application associated with a client application executing on the UE to receive the user data from the UE.

19. The method of the previous embodiment, further comprising:
at the host, transmitting input data to the client application executing on the UE, the input data being provided by executing the host application,
wherein the user data is provided by the client application in response to the input data from the host application.

20. A host configured to operate in a communication system to provide an over-the-top (OTT) service, the host comprising:
processing circuitry configured to utilize user data; and
a network interface configured to receipt of transmission of the user data to a cellular network for transmission to a user equipment (UE),
wherein the UE comprises a communication interface and processing circuitry, the communication interface and processing circuitry of the UE being configured to perform one or more of the actions described herein as performed by the wireless device 130.

21. The host of the previous embodiment, wherein the cellular network further includes a network node configured to communicate with the UE to transmit the user data from the UE to the host.

22. The host of the previous 2 embodiments, wherein:
the processing circuitry of the host is configured to execute a host application, thereby providing the user data; and
the host application is configured to interact with a client application executing on the UE, the client application being associated with the host application.

23. A method implemented by a host configured to operate in a communication system that further includes a network node and a user equipment (UE), the method comprising:
at the host, receiving user data transmitted to the host via the network node by the UE, wherein the UE performs one or more of the actions described herein as performed by the wireless device 130.

24. The method of the previous embodiment, further comprising:
at the host, executing a host application associated with a client application executing on the UE to receive the user data from the UE.

25. The method of the previous embodiments, further comprising:
at the host, transmitting input data to the client application executing on the UE, the input data being provided by executing the host application,
wherein the user data is provided by the client application in response to the input data from the host application.

### REFERENCES

1. 3GPP TS 38.212, NR; Multiplexing and channel coding (Release 17), September 2022, v. 17.3.0.
2. 3GPP TS 38.213, NR; Physical layer procedures for control (Release 17), September 2022, v. 17.3.0.
3. 3GPP TS 38.321, NR; Medium Access Control (MAC) protocol specification (Release 17), October 2022, 17.2.0.

4. 3GPP TS 38.331, NR; Radio Resource Control (RRC) protocol specification (Release 17), October 2022, 17.2.0.

1-36. (canceled)

37. A method performed by a wireless device for handling a bandwidth part (BWP), the wireless device operating in a wireless communications network, and the method comprising:
obtaining a first indication, the first indication indicating a first BWP, different than a second BWP, the second BWP being a subset of an initial BWP, the first BWP being for transmission, by a network node operating in the wireless communications network, of data to the wireless device in inactive state.

38. The method according to claim 37, wherein the obtaining of the first indication is one of:
at RRCRelease;
via a dedicated configuration;
via an information element (IE) comprised in a small data transmission (SDT) configuration;
via a cg-SDT-ConfigBWP-DL IE comprised in the SDT configuration;
via a cg-SDT-ConfigInitialBWP-DL IE comprised in the SDT configuration;
via a specific common BWP configuration;
via the specific common BWP configuration that the wireless device is enabled to switch to after receiving an initial transmission of data within a random access procedure, as part of message 4;
via an mtsdt-BWP IE;
via the mtsdt-BWP, wherein the mtsdt-BWP comprises only common parameters of a downlink BWP;
via the BWP-Downlink-SDT, comprising one of: a) common parameters and b) common parameters and dedicated parameters;
via the Mtdst-BWP comprising dedicated parameters, wherein the dedicated parameters comprise at least one of: a different CORESET than the second BWP, a different search space than the second BWP and a Non Cell Defining Synchronization Signal Block (NCD-SSB);
via System Information (SI);
via System Information Block 1 (SIB1);
via a ServingCellConfig IE received in SI;
over a paging message; and
over a Mobile Terminated Small Data Transmission (MT-SDT) paging message.

39. The method according to claim 37, wherein at least one of:
a size of a buffer comprising the data is smaller than a threshold;
the data is a small data transmission (SDT);
the data is configured for SDT;
the obtaining of the first indication is from the network node;
the first BWP is applicable as long as cell reselection is not performed;
the first indication indicates a first identifier of the first BWP and a second identifier of a CORESET, and wherein the first BWP and the CORESET are indicated in system information (SI); and
the first BWP is a downlink BWP corresponding to an uplink BWP used for Mobile Originated Small Data Transmission (MO-SDT).

40. The method according to claim 37, further comprising receiving the data from the network node in the first BWP.

41. The method according to claim 37, further comprising:
obtaining, after having obtained the first indication, a second indication indicating to switch to the first BWP;
switching to the first BWP, based on the received second indication; and
wherein the data is received from the network node in the first BWP, after having switched to the first BWP.

42. The method according to claim 41, wherein at least one of:
the switching is supported by a Downlink Control Information (DCI) format selected from DCI 0_0 and DCI 1_0, and
the second indication comprises an indicator of the first BWP to switch to.

43. The method according to claim 41, wherein the obtaining of the second indication is one of:
from the network node;
over Radio Resource Control (RRC) signalling;
while the wireless device remains in inactive state;
by expiration of a timer;
via a Medium Access Control (MAC) Control Element (CE); and
via a pre-configuration.

44. The method according to claim 37, wherein at least one of:
the subset of the initial BWP is a bandwidth of CORESET 0;
the first indication indicates a restriction of the initial BWP to CORESET 0 is removed; and
the first BWP has an allocation of up to the whole initial BWP.

45. The method according to claim 37, wherein the wireless device refrains from switching BWP, and obtains a frequency domain resource allocation of up to the entire initial DL BWP while performing small data transmissions.

46. A method performed by a network node for handling a bandwidth part (BWP), the network node operating in a wireless communications network, and the method comprising:
sending a first indication, the first indication indicating a first BWP, different than a second BWP, the second BWP being a subset of an initial BWP, the first BWP being for transmission, by the network node, of data to a wireless device, operating in the wireless communications network, in inactive state.

47. The method according to claim 46, wherein the sending of the first indication is one of:
at RRCRelease,
via a dedicated configuration,
via an information element (IE) comprised in a small data transmission (SDT) configuration,
via a cg-SDT-ConfigBWP-DL IE comprised in the SDT configuration,
via a cg-SDT-ConfigInitialBWP-DL IE comprised in the SDT configuration,
via a specific common BWP configuration,
via the specific common BWP configuration that the wireless device is enabled to switch to after receiving an initial transmission of data within a random access procedure, as part of message 4,
via an mtsdt-BWP IE,
via the mtsdt-BWP, wherein the mtsdt-BWP comprises only, common parameters of a downlink BWP,
via the BWP-Downlink-SDT, comprising one of: a) common parameters and b) common parameters and dedicated parameters,
via the Mtdst-BWP comprising dedicated parameters, wherein the dedicated parameters comprise at least one of: a different CORESET than the second BWP, a different search space than the second BWP and a Non Cell Defining Synchronization Signal Block (NCD-SSB),
via System Information (SI),
via System Information Block 1 (SIB1),
via a ServingCellConfig IE received in SI,
over a paging message, and
over a Mobile Terminated Small Data Transmission (MT-SDT) paging message.

48. The method according to claim 46, wherein at least one of:
a size of a buffer comprising the data is smaller than a threshold,
the data is a small data transmission (SDT),
the data is configured for SDT,
the sending of the first indication is to the wireless device,
the first BWP is applicable as long as cell reselection is not performed,
the first indication indicates a first identifier of the first BWP and a second identifier of a CORESET, and wherein the first BWP and the CORESET are indicated in SI, and
the first BWP is a downlink BWP corresponding to an uplink BWP used for Mobile Originated Small Data Transmission, MO-SDT.

49. The method according to claim 46, further comprising sending the data to the wireless device in the first BWP.

50. The method according to claim 46, further comprising sending, after having sent the first indication, a second indication to the wireless device indicating to switch to the first BWP, and wherein the data is sent to the wireless device in the first BWP after the wireless device has switched to the first BWP.

51. The method according to claim 50, wherein at least one of:
the switching is supported by a Downlink Control Information (DCI) format selected from DCI 0_0 and DCI 1_0, and
the second indication comprises an indicator of the first BWP to switch to.

52. The method according to claim 50, wherein the sending of the second indication is one of:
over Radio Resource Control (RRC) signalling,
while the wireless device remains in inactive state,
by expiration of a timer, and
via a Medium Access Control (MAC) Control Element (CE).

53. The method according to claim 46, wherein at least one of:
the subset of the initial BWP, is a bandwidth of CORESET 0,
the first indication indicates a restriction of the initial BWP to CORESET 0 is removed, and
the first BWP has an allocation of up to the whole initial BWP.

54. The method according to claim 46, wherein the wireless device refrains from switching BWP and obtains a frequency domain resource allocation of up to the entire initial DL BWP while performing small data transmissions.

55. A wireless device configured for operation in a wireless communication network, the wireless device comprising:
radio circuitry; and
processing circuitry operatively associated with the radio circuitry and, for handling a bandwidth part (BWP), configured to:
obtain a first indication, the first indication being configured to indicate a first BWP, different than a second BWP, the second BWP being configured to be a subset of an initial BWP, the first BWP being configured to be for transmission, by a network node configured to operate in the wireless communications network, of data to the wireless device in inactive state.

56. A network node configured for operation in a wireless communications network, the network node comprising:
radio circuitry; and
processing circuitry operatively associated with the radio circuitry and, for handling a bandwidth part (BWP), the processing circuitry configured to:
send a first indication, the first indication being configured to indicate a first BWP, different than a second BWP, the second BWP being configured to be a subset of an initial BWP, the first BWP being configured to be for transmission, by the network node, of data to a wireless device, configured to operate in the wireless communications network, in inactive state.
